(19) United States
(12) Patent Application Publication
(10) Pub. No.: US 2023/0284043 A1
(43) Pub. Date: Sep. 7, 2023

(54) Prediction Method and Terminal Device

(71) Applicant: Huawei Technologies Co., Ltd., Shenzhen (CN)

(72) Inventors: Xiaoyu Sun, Shenzhen (CN); Haiyi Liu, Shenzhen (CN); Bo Xu, Shenzhen (CN)

(21) Appl. No.: 18/005,771

(22) PCT Filed: Jul. 13, 2021
(86) PCT No.: PCT/CN2021/105987

§ 371 Date: Jan. 17, 2023

(30) Foreign Application Priority Data
Jul. 17, 2020 (CN) 202010690658.5

(51) Int. Cl. H04W 24/02; H04W 24/08

(52) U.S. Cl. CPC H04W 24/02; H04W 24/08

(57) ABSTRACT

A prediction method applied to a terminal device includes determining, by the terminal device, that first information and second information meet a first preset condition. The first information is beam history information of at least one beam and/or frequency history information of at least one frequency, and the second information is position history information of the terminal device. The method further includes predicting, by the terminal device, a target beam set and/or a target frequency set based on the first information and the second information, where the target beam set is a subset of a beam set delivered by a network device, and the target frequency set is a subset of a frequency set delivered by the network device.

This application claims priority to Chinese Patent Application No. 202010690658.5, filed with the China National Intellectual Property Administration on Jul. 17, 2020 and entitled “PREDICTION METHOD AND TERMINAL DEVICE”, which is incorporated herein by reference in its entirety.

### TECHNICAL FIELD

This application relates to the communication field, and in particular, to a prediction method and a terminal device.

### BACKGROUND

In a process of communicating with a base station, a terminal device may perform beam management or mobility management, and when performing beam management or mobility management, the terminal device needs to perform traversal measurement on a frequency near an area in which the terminal device is located and all beams at each frequency. With the development and evolution of a new radio (new radio, NR) technology, cell density, a quantity of frequencies, and a quantity of beams at a transceiver end increase significantly, and consequently, beam measurement overheads increase accordingly, and the terminal device faces urgent requirements of accelerating beam measurement and saving energy.

If the terminal device needs to measure a plurality of cells, the terminal device needs to open one or more synchronization signal block measurement time configuration (SSB measurement time configuration, SMTC) windows corresponding to each frequency in a plurality of measurement periodicities for traversal measurement, and this brings heavy power and time overheads.

For the foregoing problem, one solution is that the terminal device reports beam history information to the base station, and the base station optimizes a paging procedure or a mobility management process based on the information. A range of the beam history information is mainly described in this manner, and a specific information processing method and a specific use process are not involved. In addition, the beam history information is reported by the terminal device to the base station, and is analyzed and used by the base station, and the terminal device cannot process or use the information.

Another solution is that a cell determines, based on position information reported by a public transport means, a beam range in which the cell is located, and performs beamforming for the range. In this manner, beamforming optimization is mainly performed by the base station, and the public transport means cannot actively use the information to perform optimization. When the public transport means is in coverage of a plurality of cells, frequencies, or beams, the public transport means cannot select an optimal cell, frequency, or beam.

Therefore, how to accelerate measurement and save energy is a problem that needs to be resolved.

### SUMMARY

Embodiments of this application provide a prediction method and a terminal device, so that a beam range that needs to be measured at a to-be-measured frequency and/or at each frequency can be narrowed, and therefore measurement is accelerated, and energy is saved.

According to a first aspect, a prediction method is provided. The method is applied to a terminal device and includes: The terminal device determines that first information and second information meet a first preset condition, where the first information is beam history information of at least one beam and/or frequency history information of at least one frequency, and the second information is position history information of the terminal device; and the terminal device predicts a target beam set and/or a target frequency set based on the first information and the second information, where the target beam set is a subset of a beam set delivered by a network device, and the target frequency set is a subset of a frequency set delivered by the network device.

In the solution provided in this embodiment of this application, when it is determined that the first information and the second information meet the first preset condition, the terminal device predicts the target beam set and/or the target frequency set based on the first information and the second information, so that a beam range that needs to be measured at a to-be-measured frequency and/or at each frequency can be narrowed, and the terminal device does not need to traverse all frequencies and/or beams for measurement. In this way, measurement is accelerated, and energy is saved.

With reference to the first aspect, in some possible implementations, the first preset condition is at least one of the following conditions: an absolute value of included angle cosine of information including included angle cosine of the first information measured in different times and the second information is greater than or equal to a first threshold, and an absolute value of a correlation coefficient of the information including the included angle cosine of the first information measured in different times and the second information is greater than or equal to a second threshold.

In the solution provided in this embodiment of this application, specific content of the first preset condition is provided, so that accuracy of determining whether the terminal device predicts the target beam set and/or the target frequency set can be ensured.

With reference to the first aspect, in some possible implementations, that the terminal device predicts a target beam set based on the first information and the second information includes: The terminal device determines beam history information obtained after each of the at least one beam is measured T times and corresponding position history information of the terminal device; and the terminal device predicts the target beam set based on the beam history information obtained after each beam is measured T times and the position history information.

In the solution provided in this embodiment of this application, the terminal device predicts the target beam set based on the beam history information obtained after each beam is measured T times and the corresponding position history information of the terminal device, and the terminal device may perform measurement only on the selected target beam set. In this way, width of an SMTC window opened for beam measurement can be reduced, so that measurement is accelerated, and energy is saved.

With reference to the first aspect, in some possible implementations, that the terminal device predicts the target beam set based on the beam history information obtained after each beam is measured T times and the position history information includes: If n1 beams in the at least one beam meet a second preset condition, the terminal device combines the n1 beams into the target beam set, where the second preset condition includes: an absolute value of included angle cosine of beam history information obtained by the terminal device by performing measurement T times on each of the n1 beams and the position history information is greater than or equal to a third threshold, where n1 is a positive integer greater than or equal to 1.

With reference to the first aspect, in some possible implementations, that the terminal device predicts a target beam set based on the first information and the second information includes: The terminal device constructs a first sequence based on the second information, where the first sequence includes beam history information obtained after the at least one beam is measured T times; and the terminal device selects m beams from the first sequence, and combines the m beams into the target beam set, where the m beams are beams whose beam history information is greater than or equal to a fourth threshold in the first sequence.

In the solution provided in this embodiment of this application, the terminal device constructs the first sequence based on the second information, selects the m beams from the constructed first sequence, and combines the m beams into the target beam set, and the terminal device may perform measurement only on the selected target beam set. In this way, width of an SMTC window opened for beam measurement can be reduced, so that measurement is accelerated, and energy is saved.

With reference to the first aspect, in some possible implementations, that the terminal device predicts a target frequency set based on the first information and the second information includes: The terminal device determines frequency history information obtained after each of the at least one frequency is measured T times and corresponding position history information of the terminal device; and the terminal device predicts the target frequency set based on the frequency history information obtained after each frequency is measured T times and the position history information.

In the solution provided in this embodiment of this application, the terminal device predicts the target frequency set based on the frequency history information obtained after each frequency is measured T times and the corresponding position history information of the terminal device, and the terminal device may perform measurement only on the selected target frequency set. In this way, the terminal device does not need to traverse all frequencies for measurement, so that measurement is accelerated, and energy is saved.

With reference to the first aspect, in some possible implementations, that the terminal device predicts the target frequency set based on the frequency history information obtained after each frequency is measured T times and the position history information includes: If n2 frequencies in the at least one frequency meet a third preset condition, the terminal device combines the n2 frequencies into the target frequency set, where the third preset condition includes: an absolute value of included angle cosine of frequency history information obtained by the terminal device by performing measurement T times on each of the n2 frequencies and the position history information is greater than a fifth threshold, where n2 is a positive integer greater than or equal to 1.

With reference to the first aspect, in some possible implementations, the beam history information includes at least one of the following information: a signal to noise ratio SNR of each of the at least one beam, a signal to interference plus noise ratio SINR of each of the at least one beam, reference signal received power RSRP of each of the at least one beam, reference signal received quality RSRQ of each of the at least one beam, duration in which the terminal device camps on each of the at least one beam, and a moment/sequence in which the terminal device measures each of the at least one beam.

With reference to the first aspect, in some possible implementations, the frequency history information includes at least one of the following information: an average value of SNRs of beams included at each of the at least one frequency, an average value of SINRs included at each of the at least one frequency, RSRP included at each of the at least one frequency, RSRQ included at each of the at least one frequency, duration in which the terminal device camps on the at least one frequency, and a moment/sequence in which the terminal device measures the at least one frequency.

With reference to the first aspect, in some possible implementations, the position history information includes at least one of the following information: a position at which the terminal device performs measurement, a speed at which the terminal device performs measurement, and an acceleration at which the terminal device performs measurement.

With reference to the first aspect, in some possible implementations, the method further includes:

the terminal device measures the target beam set and/or the target frequency set to obtain a measurement result; and

if the measurement result meets a fourth preset condition, the terminal device outputs the measurement result; or

if the measurement result does not meet the fourth preset condition, the terminal device measures the beam set or the frequency set delivered by the network device.

In the solution provided in this embodiment of this application, the terminal device determines, by using a result of measurement on the predicted target beam set and/or the predicted target frequency set, whether to perform comprehensive measurement, so that practicality of the measurement result is ensured while measurement is accelerated and energy is saved.

With reference to the first aspect, in some possible implementations, the fourth preset condition includes at least one of the following conditions: actual beam strength measured by the terminal device in the target beam set and/or the target frequency set meets a threshold required for cell handover;

an absolute value of an error between actual beam strength measured by the terminal device in the target beam set and/or the target frequency set and expected beam strength corresponding to the target beam set and/or the target frequency set is less than or equal to a sixth threshold;

a weighted sum of an error between actual beam strength measured by the terminal device in the target beam set and/or the target frequency set and expected beam strength corresponding to the target beam set and/or the target frequency set is less than or equal to a seventh threshold; and

actual beam strength measured by the terminal device and actual position information meet the second preset condition and/or the third preset condition.

With reference to the first aspect, in some possible implementations, that the terminal device determines that first information and second information meet a first preset condition includes: In response to indication information received by the terminal device, the terminal device determines that the first information and the second information meet the first preset condition, where the indication information is used to indicate the terminal device to perform beam prediction.

According to a second aspect, a terminal device is provided, and includes: a processor, where the processor is configured to: determine that first information and second information meet a first preset condition, where the first information is beam history information of at least one beam and/or frequency history information of at least one frequency, and the second information is position history information of the terminal device; and predict a target beam set and/or a target frequency set based on the first information and the second information, where the target beam set is a subset of a beam set delivered by a network device, and the target frequency set is a subset of a frequency set delivered by the network device.

With reference to the second aspect, in some possible implementations, the first preset condition is at least one of the following conditions: an absolute value of included angle cosine of information including included angle cosine of the first information measured in different times and the second information is greater than or equal to a first threshold, and an absolute value of a correlation coefficient of the information including the included angle cosine of the first information measured in different times and the second information is greater than or equal to a second threshold.

With reference to the second aspect, in some possible implementations, the processor is further configured to: determine beam history information obtained after each of the at least one beam is measured T times and corresponding position history information of the terminal device; and predict the target beam set based on the beam history information obtained after each beam is measured T times and the position history information.

With reference to the second aspect, in some possible implementations, the processor is further configured to: if n1 beams in the at least one beam meet a second preset condition, combine the n1 beams into the target beam set, where the second preset condition includes: an absolute value of included angle cosine of beam history information obtained by the terminal device by performing measurement T times on each of the n1 beams and the position history information is greater than or equal to a third threshold, where n1 is a positive integer greater than or equal to 1.

With reference to the second aspect, in some possible implementations, the processor is further configured to: construct a first sequence based on the second information, where the first sequence includes beam history information obtained after the at least one beam is measured T times; and select m beams from the first sequence, and combine the m beams into the target beam set, where the m beams are beams whose beam history information is greater than or equal to a fourth threshold in the first sequence.

With reference to the second aspect, in some possible implementations, the processor is further configured to: determine frequency history information obtained after each of the at least one frequency is measured T times and corresponding position history information of the terminal device; and predict the target frequency set based on the frequency history information obtained after each frequency is measured T times and the position history information.

With reference to the second aspect, in some possible implementations, the processor is further configured to: if n2 frequencies in the at least one frequency meet a third preset condition, combine the n2 frequencies into the target frequency set, where the third preset condition includes: an absolute value of included angle cosine of frequency history information obtained by the terminal device by performing measurement T times on each of the n2 frequencies and the position history information is greater than a fifth threshold, where n2 is a positive integer greater than or equal to 1.

With reference to the second aspect, in some possible implementations, the beam history information includes at least one of the following information:

a signal to noise ratio SNR of each of the at least one beam, a signal to interference plus noise ratio SINR of each of the at least one beam, reference signal received power RSRP of each of the at least one beam, reference signal received quality RSRQ of each of the at least one beam, duration in which the terminal device camps on each of the at least one beam, and a moment/sequence in which the terminal device measures each of the at least one beam.

With reference to the second aspect, in some possible implementations, the frequency history information includes at least one of the following information: an average value of SNRs of beams included at each of the at least one frequency, an average value of SINRs included at each of the at least one frequency, RSRP included at each of the at least one frequency, RSRQ included at each of the at least one frequency, duration in which the terminal device camps on the at least one frequency, and a moment/sequence in which the terminal device measures the at least one frequency.

With reference to the second aspect, in some possible implementations, the position history information includes at least one of the following information: a position at which the terminal device performs measurement, a speed at which the terminal device performs measurement, and an acceleration at which the terminal device performs measurement.

With reference to the second aspect, in some possible implementations, the processor is further configured to:

measure the target beam set and/or the target frequency set to obtain a measurement result; and

if the measurement result meets a fourth preset condition, output the measurement result; or

if the measurement result does not meet the fourth preset condition, measure the beam set or the frequency set delivered by the network device.

With reference to the second aspect, in some possible implementations, the fourth preset condition includes at least one of the following conditions:

actual beam strength measured by the terminal device in the target beam set and/or the target frequency set meets a threshold required for cell handover;

an absolute value of an error between actual beam strength measured by the terminal device in the target beam set and/or the target frequency set and expected beam strength corresponding to the target beam set and/or the target frequency set is less than or equal to a sixth threshold;

a weighted sum of an error between actual beam strength measured by the terminal device in the target beam set and/or the target frequency set and expected beam strength corresponding to the target beam set and/or the target frequency set is less than or equal to a seventh threshold; and

actual beam strength measured by the terminal device and actual position information meet the second preset condition and/or the third preset condition.

With reference to the second aspect, in some possible implementations, the processor is further configured to: in response to indication information received by the terminal device, determine that the first information and the second information meet the first preset condition, where the indication information is used to indicate the terminal device to perform beam prediction.

For beneficial effects of the second aspect, refer to beneficial effects of the first aspect. Details are not described herein again.

According to a third aspect, this application provides a chip system. The chip system includes a processor, configured to implement functions of the terminal device in the method in the foregoing aspects. In a possible design, the chip system further includes a memory, configured to store program instructions and/or data. The chip system may include a chip, or may include a chip and another discrete device.

According to a fourth aspect, a computer-readable storage medium is provided. The computer-readable storage medium stores a computer program, and when the computer program is run, the method performed by the terminal device in the foregoing aspects is implemented.

According to a fifth aspect, a computer program product is provided. The computer program product includes computer program code, and when the computer program code is run, the method performed by the terminal device in the foregoing aspects is performed.

### BRIEF DESCRIPTION OF DRAWINGS

FIG. 1 is a schematic diagram of a wireless communication system applicable to an embodiment of this application;

FIG. 2 is a schematic diagram of a scenario in which a terminal device implements beam prediction in a cell according to an embodiment of this application;

FIG. 3 is a schematic flowchart of a prediction method according to an embodiment of this application;

FIG. 4 is a schematic flowchart of a prediction method according to another embodiment of this application;

FIG. 5 is a schematic diagram of cross-cell frequency prediction of a terminal device according to an embodiment of this application;

FIG. 6 is a schematic flowchart of a prediction method according to still another embodiment of this application;

FIG. 7 is a schematic block diagram of a terminal device according to an embodiment of this application; and

FIG. 8 is a schematic block diagram of a chip according to an embodiment of this application.

### DESCRIPTION OF EMBODIMENTS

The following describes technical solutions of this application with reference to the accompanying drawings.

Technical solutions in embodiments of this application may be applied to various communication systems such as a long term evolution (long term evolution, LTE) system, an LTE frequency division duplex (frequency division duplex, FDD) system, an LTE time division duplex (time division duplex, TDD) system, a fifth generation (5th generation, 5G) mobile communication system or an NR communication system, and a future mobile communication system.

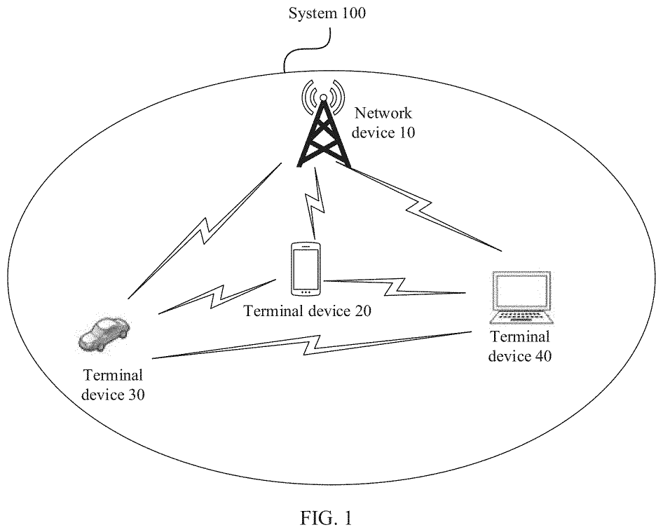

FIG. 1 is a schematic diagram of a wireless communication system 100 applicable to an embodiment of this application. As shown in FIG. 1, the wireless communication system 100 may include one or more network devices, for example, a network device 10 shown in FIG. 1. The wireless communication system 100 may further include one or more terminal devices, for example, a terminal device 20, a terminal device 30, and a terminal device 40 shown in FIG. 1.

It should be understood that FIG. 1 is only a schematic diagram. The communication system may further include another network device, for example, may further include a core network device, a wireless relay device, and a wireless backhaul device that are not shown in FIG. 1. A quantity of network devices included in the mobile communication system and a quantity of terminal devices included in the mobile communication system are not limited in this embodiment of this application.

In the mobile communication system 100, the terminal device 20, the terminal device 30, or the terminal device 40 in this embodiment of this application may also be referred to as a terminal, a terminal device, a mobile station (mobile station, MS), a mobile terminal (mobile terminal, MT), or the like. The terminal device in this embodiment of this application may be a mobile phone (mobile phone), a tablet computer (Pad), or a mobile computer with a wireless transceiver function, or may be a wireless terminal in a scenario such as virtual reality (virtual reality, VR), augmented reality (augmented reality, AR), industrial control (industrial control), self driving (self driving), remote medical (remote medical), a smart grid (smart grid), transportation safety (transportation safety), a smart city (smart city), or a smart home (smart home). In this application, the terminal device and a chip that can be applied to the terminal device are collectively referred to as the terminal device. It should be understood that a specific technology and a specific device form that are used by the terminal device are not limited in this embodiment of this application.

The network device 10 in this embodiment of this application may be a device used to communicate with the terminal device. The network device may be a base station, an evolved NodeB (evolved NodeB, eNB), a home base station, an access point (access point, AP) in a wireless fidelity (wireless fidelity, Wi-Fi) system, a wireless relay node, a wireless backhaul node, a transmission point (transmission point, TP) or a transmission and reception point (transmission and reception point, TRP), or the like, may be a gNB in an NR system, or may be a component or a part of a device forming a base station, such as a central unit (central unit, CU), a distributed unit (distributed unit, DU), or a baseband unit (baseband unit, BBU). It should be understood that a specific technology and a specific device form that are used by the network device are not limited in this embodiment of this application. In this application, the network device may be the network device, or may be a chip that is applied to the network device to complete a wireless communication processing function.

It should be understood that, in embodiments of this application, the terminal device or the network device includes a hardware layer, an operating system layer running above the hardware layer, and an application layer running above the operating system layer. The hardware layer includes hardware such as a central processing unit (central processing unit, CPU), a memory management unit (memory management unit, MMU), and a memory (also referred to as a main memory). The operating system may be any one or more computer operating systems that implement service processing through a process (process), for example, a Linux operating system, a Unix operating system, an Android operating system, an iOS operating system, or a Windows operating system. The application layer includes applications such as a browser, an address book, word processing software, and instant messaging software. In addition, a specific structure of an execution body of a method provided in embodiments of this application is not specifically limited in embodiments of this application, provided that a program that records code of the method provided in embodiments of this application can be run to perform communication according to the method provided in embodiments of this application. For example, the method provided in embodiments of this application may be performed by the terminal device or the network device, or a functional module that can invoke and execute the program in the terminal device or the network device.

In addition, aspects or features of this application may be implemented as a method, an apparatus, or a product that uses standard programming and/or engineering technologies. The term “product” used in this application covers a computer program that can be accessed from any computer-readable component, carrier, or medium. For example, the computer-readable medium may include but is not limited to: a magnetic storage component (for example, a hard disk, a floppy disk, or a magnetic tape), an optical disc (for example, a compact disc (compact disc, CD) or a digital versatile disc (digital versatile disc, DVD)), a smart card, and a flash memory component (for example, an erasable programmable read-only memory (erasable programmable read-only memory, EPROM), a card, a stick, or a key drive).

In addition, various storage media described in this specification may indicate one or more devices and/or other machine-readable storage media that are configured to store information. The term “machine-readable storage media” may include but is not limited to a wireless channel, and various other media that can store, include, and/or carry instructions and/or data.

It should be understood that division of the manners, cases, categories, and embodiments in embodiments of this application is merely for ease of description, and should not constitute a special limitation. Features in various manners, categories, cases, and embodiments may be combined in a case of no contradiction.

It should be further understood that “first”, “second”, and “third” in embodiments of this application are merely intended for distinction, and should not constitute any limitation on this application. For example, “first information” and “second information” in embodiments of this application indicate information transmitted between the network device and the terminal device.

It should be understood that sequence numbers of the foregoing processes do not mean execution sequences in embodiments of this application. The execution sequences of the processes should be determined based on functions and internal logic of the processes, and should not constitute any limitation on implementation processes of embodiments of this application.

It should be further noted that in embodiments of this application, “preset”, “predefined”, and the like may be implemented by pre-storing corresponding code or tables in a device (for example, including the terminal device and the network device) or in another manner that may be used to indicate related information. A specific implementation is not limited in this application, for example, a preset rule and a preset constant in embodiments of this application.

It should be further noted that, the term “and/or” describes an association relationship for describing associated objects and represents that three relationships may exist. For example, A and/or B may represent the following three cases: Only A exists, both A and B exist, and only B exists. The character “/” usually indicates an “or” relationship between the associated objects.

In the following embodiments, generally, the base station is used as the network device, and a communication process of a sidelink between at least two terminal devices and a communication process of an uplink between the terminal device and the base station are used as examples to specifically describe a prediction method in this application. The terminal device may be any terminal device that is in the wireless communication system and that has a wireless connection relationship with one or more network devices. It may be understood that any terminal device in the wireless communication system may implement wireless communication based on a same technical solution. This is not limited in this application.

For ease of understanding of the solutions in this application, an application scenario of this application is first briefly described below. However, it should be understood that the following content is merely intended to better understand this application, and should not constitute a special limitation on this application.

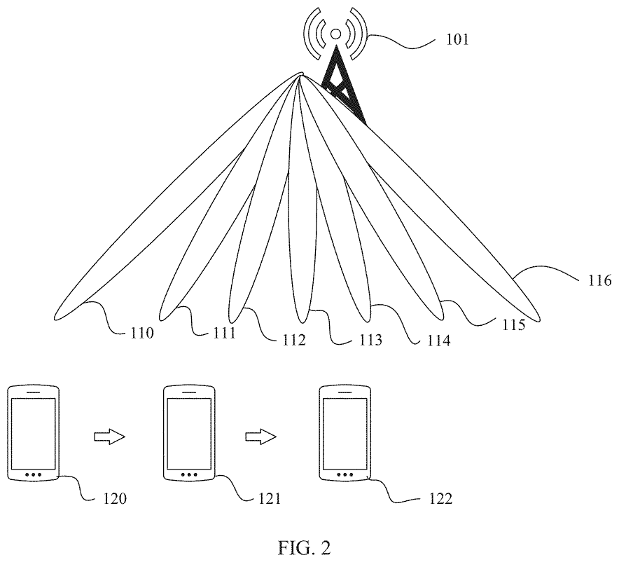

FIG. 2 is a schematic diagram of a scenario in which a terminal device implements beam prediction in a cell according to an embodiment of this application.

As shown in FIG. 2, a base station 101 (which may be understood as the network device in FIG. 1) may be configured with a plurality of antenna beams (beams 110 to 116 in FIG. 2), and a terminal device may perform beam measurement at different positions in a moving process. For example, in a process in which the terminal device moves from a position 120 to a position 122, the terminal device may separately perform beam measurement at three different positions, and select a beam that meets a requirement to communicate with the base station 101.

As shown in FIG. 2, in a process of communicating with the base station 101, the terminal device may perform beam management or mobility management, and when performing beam management or mobility management, the terminal device needs to perform traversal measurement on a frequency near an area in which the terminal device is located and all beams at each frequency. With the development and evolution of an NR technology, cell density, a quantity of frequencies, and a quantity of beams at a transceiver end increase significantly, and consequently, beam measurement overheads (including time overheads and power overheads) increase accordingly, and the terminal device faces urgent requirements of accelerating beam measurement and saving energy.

Currently, the terminal device may perform traversal measurement on all frequencies and all beam sequence numbers of a neighboring cell by using a neighboring cell frequency list delivered by a cell (which may also be referred to as the base station). Specifically, each cell corresponds to one frequency, data is transmitted to the terminal device at the frequency by using a plurality of beams, and each beam corresponds to one synchronization signal block (synchronization signal block, SSB). The cell periodically transmits the SSB corresponding to each beam in a continuous time period. A terminal device that needs to perform measurement may measure the SSB by opening an SMTC window in corresponding time, and the SMTC window needs to cover all SSBs.

If the terminal device needs to measure a plurality of cells, the terminal device needs to open one or more SMTC windows corresponding to each frequency in a plurality of measurement periodicities to perform traversal measurement. In one beam sequence number-oriented traversal measurement, the terminal device needs to open an SMTC window that covers all SSBs, and power overheads are relatively high. In one frequency-oriented traversal measurement, the terminal device needs to sequentially perform one or more times of beam sequence number-oriented traversal measurement on each frequency in a plurality of measurement periodicities, and this causes huge power overheads and time overheads.

For the foregoing problem, one solution is that the terminal device reports beam history information (including physical layer information and sensor information) to the base station, and the base station optimizes a paging procedure or a mobility management process based on the information. A range of the beam history information is mainly described in this manner, and a specific information processing method and a specific use process are not involved. In addition, the beam history information is reported by the terminal device to the base station, and is analyzed and used by the base station, and the terminal device cannot process or use the information.

Another solution is that a cell determines, based on position information reported by a public transport means, a beam range in which the cell is located, and performs beamforming for the range. In this manner, beamforming optimization is mainly performed by the base station, and the public transport means cannot actively use the information to perform optimization. When the public transport means is in coverage of a plurality of cells, frequencies, or beams, the public transport means cannot select an optimal cell, frequency, or beam.

This application provides a prediction method, so that a terminal device can narrow a beam range that needs to be measured at a to-be-measured frequency and/or at each frequency, and therefore measurement is accelerated, and energy is saved.

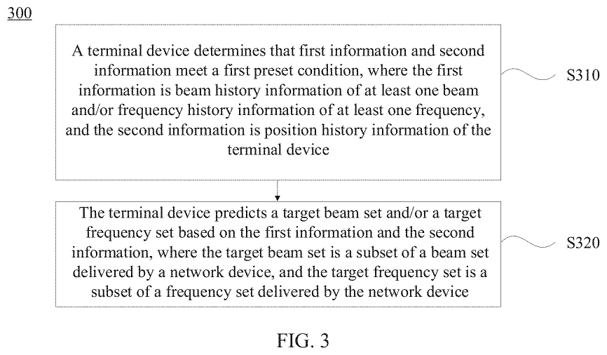

FIG. 3 is a schematic flowchart of a prediction method 300 according to an embodiment of this application. The prediction method 300 may be performed by the terminal device 20, the terminal device 30, or the terminal device 40 in FIG. 1, or the terminal device in FIG. 2. The prediction method 300 may include step S310 and step S320.

S310: The terminal device determines that first information and second information meet a first preset condition, where the first information is beam history information of at least one beam and/or frequency history information of at least one frequency, and the second information is position history information of the terminal device.

In this embodiment of this application, if the first information is the beam history information of the at least one beam, the terminal device may determine that the beam history information of the at least one beam and corresponding position history information of the terminal device meet the first preset condition; if the first information is the frequency history information of the at least one frequency, the terminal device may determine that the frequency history information of the at least one frequency and corresponding position history information of the terminal device meet the first preset condition; and if the first information is the frequency history information of the at least one frequency and the beam history information of the at least one beam, the terminal device may first determine that the frequency history information of the at least one frequency and the corresponding position history information of the terminal device meet the first preset condition, and then determine, based on a frequency that meets the first preset condition, that beam history information of at least one beam at the frequency and corresponding position history information of the terminal device meet the first preset condition.

Optionally, the beam history information in this embodiment of this application may include any one of a signal to noise ratio (signal to noise ratio, SNR) of each of the at least one beam, a signal to interference plus noise ratio (signal to interference plus noise ratio, SINR) of each of the at least one beam, reference signal received power (reference signal received power, RSRP) of each of the at least one beam, reference signal received quality (reference signal received quality, RSRQ) of each of the at least one beam, duration in which the terminal device camps on each of the at least one beam, or a moment/sequence in which the terminal device measures each of the at least one beam.

It should be noted that the moment or sequence in which the terminal device measures each of the at least one beam may also represent strength of the at least one beam. For example, it is assumed that a network device delivers a plurality of beams. If the terminal device first measures a beam 1, it may indicate that the beam 1 is stronger than other beams.

It should be understood that, in some embodiments, the beam history information may also include information obtained after at least two parameters in the foregoing information are processed. For example, an average value of the at least two parameters may be obtained, or a weighted sum of the at least two parameters is obtained. This is not limited.

For example, the weighted sum of the at least two parameters is obtained. The beam history information may include a value of a weighted sum of SNRs and SINRs of beams measured in T times; the beam history information may include a value of a weighted sum of SNRs, SINRs, and RSRP of beams measured in T times; or the beam history information may include a value of a weighted sum of SNRs, SINRs, RSRP, and RSRQ of beams measured in T times.

Optionally, the frequency history information in this embodiment of this application may include an average value of SNRs of beams included at each of the at least one frequency, an average value of SINRs included at each of the at least one frequency, RSRP included at each of the at least one frequency, RSRQ included at each of the at least one frequency, duration in which the terminal device camps on the at least one frequency, and a moment/sequence in which the terminal device measures the at least one frequency.

It should be understood that the average value in this embodiment of this application may be an arithmetic average, a geometric average, a weighted average, or the like. This is not limited.

Similarly, the moment or sequence in which the terminal device measures each of the at least one frequency may also represent strength of the at least one frequency. For example, it is assumed that the network device delivers a plurality of frequencies. If the terminal device first measures a frequency 1, it may indicate that the frequency 1 is stronger than other frequencies.

Similarly, in some embodiments, the frequency history information may also include information obtained after at least two parameters in the foregoing information are processed. For example, an average value of the at least two parameters may be obtained, or a weighted sum of the at least two parameters is obtained. This is not limited.

For example, the weighted sum of the at least two parameters is obtained. The frequency history information may include a value of a weighted sum of SNRs and SINRs of frequencies measured in T times; the frequency history information may include a value of a weighted sum of SNRs, SINRs, and RSRP of frequencies measured in T times; or the frequency history information may include a value of a weighted sum of SNRs, SINRs, RSRP, and RSRQ of frequencies measured in T times.

It should be noted that the SNR may also be referred to as a signal to noise ratio, and is a ratio of a signal to noise in an electronic device, and the SINR may also be referred to as a signal to interference plus noise ratio, and is a ratio of strength of a useful signal received by the electronic device to strength of a received interference signal.

Optionally, the position history information in this embodiment of this application includes at least one of the following information: a position at which the terminal device performs measurement, a speed at which the terminal device performs measurement, and an acceleration at which the terminal device performs measurement.

In this embodiment of this application, the position at which the terminal device performs the measurement may be a distance between coordinates of the terminal device at a t^{th} time of measurement and coordinates of the terminal device at a Oth time of measurement.

In this embodiment of this application, the position at which the terminal device performs measurement may be obtained by using a position sensor, and the speed or the acceleration at which the terminal device performs measurement may be obtained by using a speedometer or an accelerometer.

S320: The terminal device predicts a target beam set and/or a target frequency set based on the first information and the second information, where the target beam set is a subset of a beam set delivered by the network device, and the target frequency set is a subset of a frequency set delivered by the network device.

In this embodiment of this application, if the first information is the beam history information of the at least one beam, the terminal device may predict the target beam set based on the beam history information of the at least one beam and the position history information; if the first information is the frequency history information of the at least one frequency, the terminal device may predict the target frequency set based on the frequency history information of the at least one frequency and the position history information; and if the first information is the frequency history information of the at least one frequency and the beam history information of the at least one beam, the terminal device may first predict the target frequency set based on the frequency history information of the at least one frequency and the position history information, and then predict the target beam set based on beam history information of at least one beam and the position history information in the target frequency set.

In the solution provided in this embodiment of this application, when it is determined that the first information and the second information meet the first preset condition, the terminal device predicts the target beam set and/or the target frequency set based on the first information and the second information, so that a beam range that needs to be measured at a to-be-measured frequency and/or at each frequency can be narrowed, and the terminal device does not need to traverse all frequencies and/or beams for measurement. In this way, measurement is accelerated, and energy is saved.

Optionally, in some embodiments, the first preset condition is at least one of the following conditions: an absolute value of included angle cosine of information including included angle cosine of the first information measured in different times and the second information is greater than or equal to a first threshold, and an absolute value of a correlation coefficient of the information including the included angle cosine of the first information measured in different times and the second information is greater than or equal to a second threshold.

Case 1:

The first preset condition is that an absolute value of included angle cosine of information including included angle cosine of the first information measured in different times and the second information is greater than or equal to a first threshold.

For example, the beam history information is RSRP. RSRP of all beams at a t^{th} time of measurement of the terminal device may be defined as:

\vec{q₁}=(q_{t,1},q_{t,2}, . . . ,q_{t,N}) (1)

An i^{th} element q_{t,i} represents measured RSRP of an i^{th} beam at the t^{th} time of measurement.

The beam history information is defined as:

\vec{r}=(r₁,r₂, . . . ,r_{T}) (2)

A t^{th} element rₜ represents included angle cosine of RSRP \vec{qₜ} of all beams at the t^{th} time of measurement and RSRP \vec{q₀} of all the beams at a 0^{th} time of measurement.

$${r}_{t} = cos ( {\vec{q}}_{t} , {\vec{q}}_{0} ) = \frac{{\vec{q}}_{t} \cdot {\vec{q}}_{0}}{\vert {\vec{q}}_{t} \vert \cdot \vert {\vec{q}}_{0} \vert} \qquad ( 3 )$$

The beam history information \vec{r} may indicate that fluctuation of measurement results of the terminal device in full beam directions relative to a start measurement result with time.

Position history information obtained when the terminal device performs measurement T times on the beam may be represented as:

\vec{s}=(s₁,s₂, . . . ,s_{T}) (4)

sₜ represents position history information of the terminal device at the t^{th} time of measurement.

It is assumed that the position history information of the terminal device at the t^{th} time of measurement is a distance between a coordinate position at which the terminal device is located at the t^{th} time of measurement and a coordinate position at which the terminal device is located at the 0^{th} time of measurement, that is:

sₜ=|\vec{lₜ}−\vec{l₀}|=\sqrt{(xₜ−x₀)²+(yₜ−y₀)²+(zₜ−z₀)²} (5)

The terminal device may calculate an absolute value of the included angle cosine of the beam history information and the position history information by using the following formula (6), and determine, based on the absolute value of the included angle cosine and the first threshold, whether to predict the target beam set.

$$cos ( \vec{s} , \vec{r} ) = \frac{\vec{s} \cdot \vec{r}}{\vert \vec{s} \vert \cdot \vert \vec{r} \vert} \qquad ( 6 )$$

For example, the beam history information is RSRP. It is assumed that the network device delivers five beams: a beam 1, a beam 2, a beam 3, a beam 4, and a beam 5. The terminal device measures the five beams five times, and position history information of the terminal device in the five times of measurement is \vec{s}=(s₁, s₂, . . . , s₅)=(10, 15, 12, 16, 18). RSRP of the five beams that is measured by the terminal device at a first time of measurement is \vec{q₁}=(q_{1,1}, q_{1,2}, . . . , g_{1,5})=(60, 50, 65, 70, 50), RSRP of the five beams that is measured by the terminal device at a second time of measurement is \vec{q₂}=(q_{2,1}, q_{2,2}, . . . , q_{2,5})=(40, 60, 35, 50, 30), RSRP of the five beams that is measured by the terminal device at a third time of measurement is \vec{q₃}=(q_{3,1}, q_{3,2}, . . . , q_{3,5})=(30, 50, 25, 50, 40), RSRP of the five beams that is measured by the terminal device at a fourth time of measurement is \vec{q₃}=(q_{4,1}, q_{4,2}, . . . , q_{4,5})=(30, 40, 40, 50, 20), and RSRP of the five beams that is measured by the terminal device at a fifth time of measurement is \vec{q₅}=(q_{5,1}, q_{5,2}, . . . , q_{5,5})=(10, 20, 45, 20, 10). If RSRP of the five beams that is measured by the terminal device at a 0^{th} time of measurement is \vec{q₀}=(q_{0,1}, q_{0,2}, . . . , q_{0,5})=(40, 30, 25, 10, 30), values of all elements in \vec{r} may be first calculated by using the foregoing formula (3).

$${r}_{1} = cos ( {\vec{q}}_{1} , {\vec{q}}_{0} ) = \frac{{\vec{q}}_{1} \cdot {\vec{q}}_{0}}{\vert {\vec{q}}_{1} \vert \cdot \vert {\vec{q}}_{0} \vert} = 0.9$$

$${r}_{2} = cos ( {\vec{q}}_{2} , {\vec{q}}_{0} ) = \frac{{\vec{q}}_{2} \cdot {\vec{q}}_{0}}{\vert {\vec{q}}_{2} \vert \cdot \vert {\vec{q}}_{0} \vert} = 0.89$$

$${r}_{3} = cos ( {\vec{q}}_{3} , {\vec{q}}_{0} ) = \frac{{\vec{q}}_{3} \cdot {\vec{q}}_{0}}{\vert {\vec{q}}_{3} \vert \cdot \vert {\vec{q}}_{0} \vert} = 0.87$$

$${r}_{4} = cos ( {\vec{q}}_{4} , {\vec{q}}_{0} ) = \frac{{\vec{q}}_{4} \cdot {\vec{q}}_{0}}{\vert {\vec{q}}_{4} \vert \cdot \vert {\vec{q}}_{0} \vert} = 0.84$$

$${r}_{5} = cos ( {\vec{q}}_{5} , {\vec{q}}_{0} ) = \frac{{\vec{q}}_{5} \cdot {\vec{q}}_{0}}{\vert {\vec{q}}_{5} \vert \cdot \vert {\vec{q}}_{0} \vert} = 0.75$$

In this case, \vec{r}=(r₁, r₂, . . . , r₅)=(0.90, 0.89, 0.87, 0.84, 0.75).

The terminal device may calculate the included angle cosine of the beam history information (the beam history information herein is \vec{r} calculated above) and the position history information by using the foregoing formula (6).

$$\begin{matrix}cos ( \vec{s} , \vec{r} ) = \frac{\vec{s} \cdot \vec{r}}{\vert \vec{s} \vert \cdot \vert \vec{r} \vert} = \frac{\begin{matrix}10 \times 0.9 + 15 \times 0.89 + 12 \times \\ 0.87 + 16 \times 0.84 + 18 \times 0.75\end{matrix}}{\begin{matrix}\sqrt{{10}^{2} + {15}^{2} + {12}^{2} + {16}^{2} + {18}^{2}} \times \\ \sqrt{{0.9}^{2} + {0.89}^{2} + {0.87}^{2} + {0.84}^{2} + {0.75}^{2}}\end{matrix}} \\ = 0.97\end{matrix}$$

If the first threshold is 0.5, because the included angle cosine of the beam history information and the position history information is 0.97, and is greater than the first threshold, the target beam set and/or the target frequency set may be predicted based on the first information and the second information.

Case 2:

An absolute value of a correlation coefficient of the information including the included angle cosine of the first information measured in different times and the second information is greater than or equal to a second threshold.

The correlation coefficient in this embodiment of this application may include but is not limited to the following correlation coefficients: a Pearson correlation coefficient, a Spearman correlation coefficient, and a Kendall correlation coefficient.

The Pearson correlation coefficient is used as an example. A correlation coefficient of two variables may be expressed as:

$$ρ ( X , Y ) = \frac{cov ( X , Y )}{{σ}_{X} \cdot {σ}_{Y}} = \frac{E ( X , Y ) - E ( X ) E ( Y )}{\sqrt{E ( {X}^{2} ) - {E}^{2} ( X )} \cdot \sqrt{E ( {Y}^{2} ) - {E}^{2} ( Y )}} \qquad ( 7 )$$

ρ(X, Y) represents a correlation coefficient of X and Y, cov(X, Y) represents a covariance of X and Y, σ_{X} and σ_{Y} respectively represent a standard deviation of X and a standard deviation of Y, E(X, Y) represents a mathematical expectation of X and Y, E(X) and E(Y) are respectively a mathematical expectation of X and a mathematical expectation of Y, and E(X²) and E(X²) are respectively a mathematical expectation of X² and a mathematical expectation of Y².

RSRP is still used as an example of the beam history information. As described above, if \vec{r}=(r₁, r₂, . . . , r₅)=(0.90, 0.89, 0.87, 0.84, 0.75) is obtained by using the foregoing formula, and the position history information of the terminal device obtained after the terminal device performs measurement T times is \vec{s}=(s₁, s₂, L, s₅)=(10, 15, 12, 16, 18), a correlation coefficient of the two variables may be calculated based on the foregoing formula (7) as follows:

$$\begin{matrix}ρ ( \vec{s} , \vec{r} ) = \frac{cov ( \vec{s} , \vec{r} )}{{σ}_{\vec{s}} \cdot {σ}_{\vec{r}}} = \frac{E ( \vec{s} , \vec{r} ) - E ( \vec{s} ) E ( \vec{r} )}{\sqrt{E ( {\vec{s}}^{2} ) - {E}^{2} ( \vec{s} )} \cdot \sqrt{E ( {\vec{r}}^{2} ) - {E}^{2} ( \vec{r} )}} \\ = \frac{11.946 - 14.2 \times 0.85}{\sqrt{209.8 - 201.64} \times \sqrt{0.72542 - 0.4675}} = - 0.027\end{matrix}$$

If the second threshold is 0.3, because an absolute value of the correlation coefficient of \vec{s} and \vec{r} is 0.027, and is less than the second threshold 0.3, and the first preset condition is not met, the terminal device may not predict the target beam set and/or the target frequency set based on the first information and the second information.

Certainly, in some embodiments, the foregoing two conditions in the first preset condition may alternatively be simultaneously calculated. If the two conditions are contradictory, whether to predict the target beam set and/or the target frequency set may be determined mainly by using either condition.

In the solution provided in this embodiment of this application, specific content of the first preset condition is provided, so that accuracy of determining whether the terminal device predicts the target beam set and/or the target frequency set can be ensured.

In addition, in some embodiments, the terminal device may also determine, based on whether a region covered by a plurality of previously accessed beams covers an expected access position, whether to predict the target beam set and/or the target frequency set.

For example, if the terminal device expects to access a preset position, and a beam finally accessed by the terminal device after a plurality of times of measurement may cover the preset position, the terminal device may predict the target beam set and/or the target frequency set based on the first information and the second information.

It is pointed out above that the terminal device may predict the target beam set and/or the target frequency set based on the first information and the second information. Descriptions are provided below by using a manner 1 to a manner 3.

Manner 1

That the terminal device predicts a target beam set based on the first information and the second information includes: The terminal device determines beam history information obtained after each of the at least one beam is measured T times and corresponding position history information of the terminal device; and the terminal device predicts the target beam set based on the beam history information obtained after each beam is measured T times and the position history information.

In this embodiment of this application, the terminal device may first predict each beam delivered by the network device. Specifically, the target beam set may be predicted based on beam history information obtained after each beam is measured T times and corresponding position history information of the terminal device, so that the terminal device may perform measurement only on the predicted target beam set. In this way, a beam range that needs to be measured can be narrowed, beam measurement is accelerated, and energy is saved.

It should be noted that the corresponding position history information of the terminal device may be understood as a distance between a coordinate position at which the terminal device is located at a t^{th} time of beam measurement and a coordinate position at which the terminal device is located at a 0^{th} time of beam measurement, or may be understood as a speed or an acceleration of the terminal device when the terminal device measures the beam at the t^{th} time.

In some embodiments, the corresponding position history information of the terminal device may be an arithmetic average value, a root mean square value, or a weighted average value of the foregoing several parameters. This is not limited.

It may be understood that, when the terminal device measures the beam at the t^{th} time, beam history information of all beams delivered by the network device may be obtained. In other words, each time the terminal device performs measurement, beam history information of a plurality of beams may be obtained.

In the solution provided in this embodiment of this application, the terminal device predicts the target beam set based on the beam history information obtained after each beam is measured T times and the corresponding position history information of the terminal device, and the terminal device may perform measurement only on the selected target beam set. In this way, width of an SMTC window opened for beam measurement can be reduced, so that measurement is accelerated, and energy is saved.

Optionally, in some embodiments, that the terminal device predicts the target beam set based on the beam history information obtained after each beam is measured T times and the position history information includes:

if n1 beams in the at least one beam meet a second preset condition, the terminal device combines the n1 beams into the target beam set, where the second preset condition includes: an absolute value of included angle cosine of beam history information obtained by the terminal device by performing measurement T times on each of the n1 beams and the position history information is greater than or equal to a third threshold, where n1 is a positive integer greater than or equal to 1.

In this embodiment of this application, the target beam set may be formed by combining the n1 beams that are in at least one beam delivered by the network device and that meet the second preset condition.

Beam history information of an i^{th} beam may be represented as:

\vec{bᵢ}=(b_{i,1},b_{i,2}, . . . b_{i,T}) (8)

The position history information of the terminal device obtained when the terminal device performs measurement T times may be represented by using the foregoing formula (4). In this case, the terminal device may calculate included angle cosine of beam history information obtained after the i^{th} beam is measured T times and corresponding position history information of the terminal device by using formula (9).

$$cos ( \vec{s} , {\vec{b}}_{i} ) = \frac{\vec{s} \cdot {\vec{b}}_{i}}{\vert \vec{s} \vert \cdot \vert {\vec{b}}_{i} \vert} \qquad ( 9 )$$

Case 1: The beam history information is one of a plurality of pieces of information.

For example, the beam history information is RSRP. It is assumed that the network device delivers five beams: a beam 1, a beam 2, a beam 3, a beam 4, and a beam 5. The terminal device measures the five beams five times, and position history information of the terminal device in the five times of measurement is \vec{s}=(s₁, s₂, . . . , s₅)=(10, 15, 12, 16, 18). RSRP of a measured first beam (that is, the beam 1) is \vec{b₁}=(b_{1,1}, b_{1,2}, . . . , b_{1,5})=(60, 50, 65, 70, 50), and in this case, included angle cosine of the two vectors is:

$$cos ( \vec{s} , {\vec{b}}_{1} ) = \frac{\vec{s} \cdot {\vec{b}}_{1}}{\vert \vec{s} \vert \cdot \vert {\vec{b}}_{1} \vert} = \frac{10 \times 60 + 15 \times 50 + 12 \times 65 + 16 \times 70 + 18 \times 50}{\sqrt{1 {0}^{2} + 1 {5}^{2} + {12}^{2} + 1 {6}^{2} + 1 {8}^{2}} \times \sqrt{6 {0}^{2} + 5 {0}^{2} + 6 {5}^{2} + 7 {0}^{2} + 5 {0}^{2}}} = 0 \text{.96}$$

It is assumed that the third threshold is 0.5. Because the included angle cosine of the beam history information of the first beam and the corresponding position history information of the terminal device is 0.96, and is greater than the second threshold 0.5, the first beam may be added to the target beam set.

Similarly, it is assumed that RSRP of a second beam (that is, the beam 2) is \vec{b₂}=(b_{2,1}, b_{2,2}, . . . , b_{2,5})=(40, 10, 25, 2, 30) and position history information of the terminal device in the T times of measurement is still \vec{s}=(s₁, s₂, . . . , s₅)=(10, 15, 12, 16, 18), and in this case, included angle cosine of the two vectors is:

$$cos ( \vec{s} , {\vec{b}}_{2} ) = \frac{\vec{s} \cdot {\vec{b}}_{2}}{\vert \vec{s} \vert \cdot \vert {\vec{b}}_{2} \vert} = \frac{10 \times 40 + 15 \times 10 + 12 \times 25 + 16 \times 2 + 18 \times 30}{\sqrt{1 {0}^{2} + 1 {5}^{2} + 1 {2}^{2} + {16}^{2} + 1 {8}^{2}} \times \sqrt{4 {0}^{2} + 1 {0}^{2} + 2 {5}^{2} + {2}^{2} + 3 {0}^{2}}} = 0 \text{.77}$$

Because the included angle cosine of the beam history information of the second beam and the corresponding position history information of the terminal device is 0.77, and is greater than the third threshold, the second beam may be added to the target beam set.

Similarly, for another beam, a same method as the foregoing method may be used to determine whether to add the beam to the target beam set.

In some embodiments, the terminal device may alternatively first calculate included angle cosine of beam history information of each beam in all beams and corresponding position history information of the terminal device, and then combine beams whose included angle cosine is greater than or equal to the third threshold into the target beam set in this application.

Case 2: The beam history information is information obtained after at least two parameters in a plurality of pieces of information are processed.

For example, the beam history information is RSRP and RSRQ. It is assumed that the terminal device performs measurement five times, and position history information of the terminal device in the five times of measurement is \vec{s}=(s₁, s₂, . . . , s₅)=(10, 15, 12, 16, 18). RSRP of a measured first beam (that is, the beam 1) is [symbol] =(b_{1,1}, b_{1,2}, . . . , b_{1,5})=(60, 50, 65, 70, 50), and RSRQ of the measured first beam is [symbol] =(b_{1,1}, b_{1,2}, . . . , b_{1,5})=(30, 40, 15, 40, 40). Therefore, beam history information of the first beam may be an average value of the RSRP and the RSRQ of the first beam. An arithmetic average value is used as an example; in other words, the beam history information of the first beam is:

\vec{b₁}=(b_{1,1},b_{1,2}, . . . ,b_{1,5})=(45,45,40,55,45)

Included angle cosine of the beam history information of the first beam and the corresponding position history information of the terminal device may be calculated as follows by using the foregoing formula (5):

$$cos ( \vec{s} , {\vec{b}}_{1} ) = \frac{\vec{s} \cdot {\vec{b}}_{1}}{\vert \vec{s} \vert \cdot \vert {\vec{b}}_{1} \vert} = \frac{10 \times 45 + 15 \times 45 + 12 \times 40 + 16 \times 55 + 18 \times 45}{\sqrt{1 {0}^{2} + 1 {5}^{2} + 1 {2}^{2} + 1 {6}^{2} + 1 {8}^{2}} \times \sqrt{4 {5}^{2} + 4 {5}^{2} + 4 {0}^{2} + 5 {5}^{2} + 4 {5}^{2}}} = 0 \text{.98}$$

Because the included angle cosine of the beam history information of the first beam and the corresponding position history information of the terminal device is 0.98, and is greater than the third threshold 0.5, the first beam may be added to the target beam set.

Similarly, for a second beam (that is, the beam 2), calculation may also be performed based on a same method as the foregoing method. It is assumed that position history information of the terminal device in T times of measurement is still \vec{s}=(s₁, s₂, . . . , s₅)=(10, 15, 12, 16, 18), RSRP of the measured second beam is [symbol] =(b_{2,1}, b_{2,2}, . . . , b_{2,5})=(40, 10, 25, 2, 30), and RSRQ of the measured second beam is [symbol] =(b_{2,1}, b_{2,2}, . . . , b_{2,5})=(20, 30, 15, 4, 10). Therefore, beam history information of the second beam may be an average value of the RSRP and the RSRQ of the second beam. An arithmetic average value is used as an example; in other words, the beam history information of the second beam is:

\vec{b₂}=(b_{2,1},b_{2,2}, . . . ,b_{2,5})=(30,20,20,3,20)

Included angle cosine of the beam history information of the second beam and the corresponding position history information of the terminal device may be calculated as follows by using the foregoing formula (5):

$$cos ( \vec{s} , {\vec{b}}_{2} ) = \frac{\vec{s} \cdot {\vec{b}}_{2}}{\vert \vec{s} \vert \cdot \vert {\vec{b}}_{2} \vert} = \frac{10 \times 30 + 15 \times 20 + 12 \times 20 + 16 \times 3 + 18 \times 20}{\sqrt{1 {0}^{2} + 1 {5}^{2} + 1 {2}^{2} + 1 {6}^{2} + {18}^{2}} \times \sqrt{3 {0}^{2} + 2 {0}^{2} + 2 {0}^{2} + {3}^{2} + 2 {0}^{2}}} = 0 \text{.84}$$

Because the included angle cosine of the beam history information of the second beam and the corresponding position history information of the terminal device is 0.84, and is greater than the third threshold, the second beam may be added to the target beam set.

Similarly, for another beam, a same method as the foregoing method may be used to determine whether to add the beam to the target beam set.

In some embodiments, the terminal device may alternatively first calculate included angle cosine of beam history information of each beam in all beams and corresponding position history information of the terminal device, and then combine beams whose included angle cosine is greater than or equal to the third threshold into the target beam set in this application.

It should be noted that in this embodiment of this application, for different beams, included angle cosine of the beams may be calculated by using the method in the case 1 in the foregoing method 1; included angle cosine of the beams may be calculated by using the method in the case 2 in the foregoing method 1; or included angle cosine of some of the beams may be calculated by using the method in the case 1, and included angle cosine of some of the beams is calculated by using the method in the case 2. This is not specifically limited in this application.

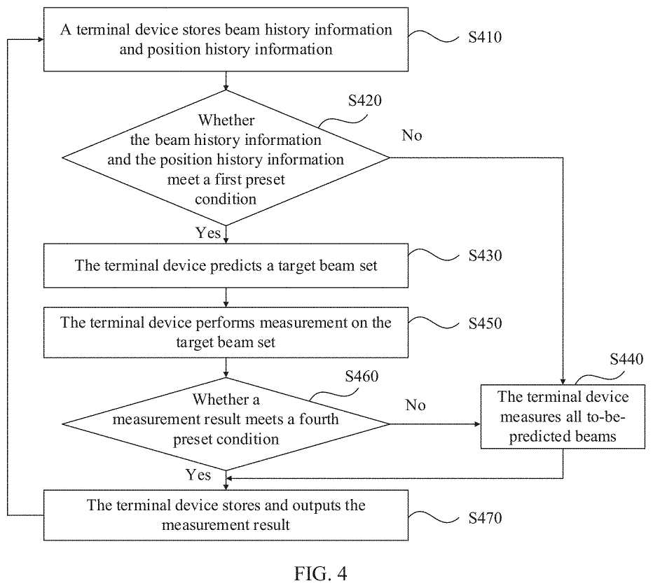

For ease of understanding, the method in the manner 1 is summarized below with reference to FIG. 4. FIG. 4 is a schematic flowchart of a prediction method according to another embodiment of this application. The method may include step S410 to step S470.

S410: A terminal device stores beam history information and position history information.

S420: Determine whether the beam history information and the position history information meet a first preset condition.

If yes, step S430 is performed; and if no, step S440 is performed.

S430: The terminal device predicts a target beam set.

S440: The terminal device measures all to-be-predicted beams.

S450: The terminal device performs measurement on the target beam set.

S460: Determine whether a measurement result meets a fourth preset condition.

If yes, step S470 is performed; and if no, step S440 is performed.

S470: The terminal device stores and outputs the measurement result.

For step S410 to step S430, refer to content of the foregoing manner 1, and for step S440 to step S470, refer to related content of the fourth preset condition below. For brevity, details are not described herein again.

Manner 2

That the terminal device predicts a target beam set based on the first information and the second information includes: The terminal device constructs a first sequence based on the second information, where the first sequence includes beam history information obtained after the at least one beam is measured T times; and the terminal device selects m beams from the first sequence, and combines the m beams into the target beam set, where the m beams are beams whose beam history information is greater than or equal to a fourth threshold in the first sequence.

In this embodiment of this application, a sequence of the position history information may be first constructed based on the second information, to obtain a linear equation combination, and a coefficient of the linear equation combination is solved, and then the first sequence in this application is constructed based on the coefficient obtained through solution.

Case 1: The beam history information is one of a plurality of pieces of information.

For example, the beam history information is RSRP. It is assumed that the network device delivers five beams: a beam 1, a beam 2, a beam 3, a beam 4, and a beam 5. Coordinate positions of the terminal device in three preceding times of a current time of measurement are respectively \vec{lₜ₋₁}=(5, 20, 15), \vec{lₜ₋₂}=(15, 24, 10), and \vec{lₜ₋₃}=(8, 12, 20), and RSRP corresponding to the five beams in the three preceding times of measurement are respectively \vec{qₜ₋₁}=(60, 50, 65, 70, 50), \vec{qₜ₋₂}=(40, 10, 25, 20, 30), and \vec{qₜ₋₃}=(50, 20, 42, 20, 40). If current coordinates of the terminal device are lₜ=(23, 50, 5), the current coordinates of the terminal device may represent a linear combination of coordinates of the terminal device in the three preceding times, as shown in formula (10).

\vec{lₜ}=a\vec{lₜ₋₁}+b\vec{lₜ₋₂}+c\vec{lₜ₋₃} (10)

To be specific,

$$\{ \begin{matrix}23 = a \times 5 + b \times 15 + c \times 8 \\ 50 = a \times 20 + b \times 24 + c \times 12 . \\ 5 = a \times 15 + b \times 10 + c \times 20\end{matrix}$$

After the foregoing linear equation combination is solved, coefficients a, b, and c of the linear equation combination may be respectively obtained as: 1, 2, and −1.5.

The terminal device may construct RSRP \vec{qₜ}=a\vec{qₜ₋₁}+b\vec{qₜ₋₂}+c\vec{qₜ₋₃}, at a t^{th} time by using the coefficients of the linear equation combination.

$$\begin{matrix}\vec{{q}_{t}} = a \vec{{q}_{t - 1}} + b \vec{{q}_{t - 2}} + c \vec{{q}_{t - 3}} \\ = 1 \times ( 60 , 50 , 65 , 70 , 50 ) + 2 \times ( 40 , 10 , 25 , 20 , 30 ) - 1.5 \times ( 50 , 20 , 42 , 20 , 40 ) \\ = ( 65 , 40 , 52 , 80 , 50 )\end{matrix}$$

If the fourth threshold in this application is 60, beams in the target beam set may be beams corresponding to RSRP 65 and RSRP 80; in other words, the beam 1 and the beam 4 may be combined into the target beam set in this application.

Case 2: The beam history information is information obtained after at least two parameters in a plurality of pieces of information are processed.

For example, the beam history information is RSRP and RSRQ. It is assumed that the network device delivers five beams: a beam 1, a beam 2, a beam 3, a beam 4, and a beam 5. The terminal device performs measurement five times. RSRP of a beam measured at a (t−1)^{th} time is [symbol] =(60, 50, 65, 70, 50), and RSRQ of the beam measured at the (t−1)^{th} time is [symbol] =(30, 40, 15, 40, 40). Therefore, beam history information of the beam measured at the (t−1)^{th} time may be an average value of the RSRP and the RSRQ of the beam measured at the (t−1)^{th} time. An arithmetic average value is used as an example; in other words, the beam history information of the beam measured at the (t−1)^{th} time is:

\vec{qₜ₋₁}=(45,45,40,55,45)

Similarly, same processing is performed on RSRP and RSRQ measured at a (t−2)^{th} time and a (t−3)^{th} time, to obtain beam history information of beams measured at the (t−2)^{th} time and the (t−3)^{th} time.

It is assumed that \vec{qₜ₋₂}=(40, 25, 30, 32, 55) and

\vec{qₜ₋₃}=(20,45,10,62,50).

If coordinates of the terminal device in three preceding times of a current time of measurement are respectively \vec{lₜ₋₁}=(5, 20, 15), \vec{lₜ₋₂}=(15, 24, 10), and \vec{lₜ₋₃}=(8, 12, 20), and current coordinates of the terminal device are lₜ=(23, 50, 5), the current coordinates of the terminal device may represent a linear combination of coordinates of the terminal device in the three preceding times.

It may be learned based on the foregoing formula (10) that coefficients a, b, and c of a linear equation combination are respectively 1, 2, and −1.5.

The terminal device may construct RSRP \vec{qₜ}=a\vec{qₜ₋₁}+b\vec{qₜ₋₂}+c\vec{qₜ₋₃} at a t^{th} time by using the coefficients of the linear equation combination.

$$\begin{matrix}\vec{{q}_{t}} = a \vec{{q}_{t - 1}} + b \vec{{q}_{t - 2}} + c \vec{{q}_{t - 3}} \\ = 1 \times ( 45 , 45 , 40 , 55 , 45 ) + 2 \times ( 40 , 25 , 30 , 32 , 55 ) - 1 \text{.5} \times ( 20 , 45 , 10 , 62 , 50 ) \\ = ( 95 , 27.5 , 85 , 28 , 80\end{matrix}$$

If the fourth threshold in this application is 60, beams in the target beam set may be beams corresponding to RSRP 95, RSRP 85, and RSRP 80; in other words, the beam 1, the beam 3, and the beam 5 may be combined into the target beam set in this application.

It should be understood that the foregoing values are merely examples for description, and may alternatively be other values. This should not constitute a special limitation on this application.

It should be noted that construction of the first sequence by using a result of the three preceding times of measurement in the foregoing embodiment is merely an example for description. In an actual prediction process, the first sequence may be constructed based on a result of n preceding times of measurement, and n is a positive integer greater than or equal to 1. This is not limited.

In the solution provided in this embodiment of this application, the terminal device constructs the first sequence based on the second information, selects the m beams from the constructed first sequence, and combines the m beams into the target beam set, and the terminal device may perform measurement only on the selected target beam set. In this way, width of an SMTC window opened for beam measurement can be reduced, so that measurement is accelerated, and energy is saved.

Manner 3

That the terminal device predicts a target frequency set based on the first information and the second information includes: The terminal device determines frequency history information obtained after each of the at least one frequency is measured T times and corresponding position history information of the terminal device; and the terminal device predicts the target frequency set based on the frequency history information obtained after each frequency is measured T times and the position history information.

In this embodiment of this application, the terminal device may first predict each frequency delivered by the network device. Specifically, the target frequency set may be predicted based on frequency history information obtained after each frequency is measured T times and corresponding position history information of the terminal device, so that the terminal device may perform measurement only on the predicted target frequency set. In this way, a frequency range that needs to be measured can be narrowed, measurement is accelerated, and energy is saved.

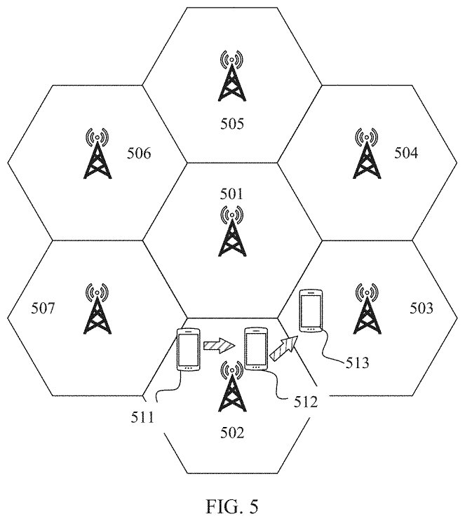

FIG. 5 is a schematic diagram of cross-cell frequency prediction of a terminal device according to an embodiment of this application. 501 to 507 in FIG. 5 represent different base stations, and a moving track of the terminal device may span a plurality of base stations (cells). When the terminal device approaches a cell edge, cell handover may be faced. In this case, a network-side device delivers a neighboring cell frequency for the terminal device to measure. In a moving process, the terminal device may measure a current cell and a neighboring cell at different positions (511 to 513), and select a beam that meets a requirement to communicate with a base station.

It should be noted that the corresponding position history information of the terminal device may be understood as a distance between a coordinate position at which the terminal device is located at a t^{th} time of beam measurement and a coordinate position at which the terminal device is located at a 0^{th} time of beam measurement, or may be understood as a speed or an acceleration of the terminal device when the terminal device measures the beam at the t^{th} time.

It may be understood that, when the terminal device measures the frequency at the t^{th} time, frequency history information of a plurality of frequencies delivered by the network device may be obtained. In other words, each time the terminal device performs measurement, frequency history information of a plurality of frequencies may be obtained.

In the solution provided in this embodiment of this application, the terminal device predicts the target frequency set based on the frequency history information obtained after each frequency is measured T times and the corresponding position history information of the terminal device, and the terminal device may perform measurement only on the selected target frequency set. In this way, the terminal device does not need to traverse all frequencies for measurement, so that measurement is accelerated, and energy is saved.

Optionally, in some embodiments, that the terminal device predicts the target frequency set based on the frequency history information obtained after each frequency is measured T times and the position history information includes: If n2 frequencies in the at least one frequency meet a third preset condition, the terminal device combines the n2 frequencies into the target frequency set, where the third preset condition includes: an absolute value of included angle cosine of frequency history information obtained by the terminal device by performing measurement T times on each of the n2 frequencies and the position history information is greater than or equal to a fifth threshold, where n2 is a positive integer greater than or equal to 1.

In this embodiment of this application, the target frequency set may be formed by combining n2 beams that are in at least one frequency delivered by the network device and that meet the third preset condition.

Frequency history information of a k^{th} frequency may be represented as:

\vec{pₖ}=(p_{k,1},p_{k,2}, . . . ,p_{k,T}) (11)

p_{k,t} represents an average value of all beam history information of the k^{th} frequency at a t^{th} time of measurement, and may be represented as:

$${P}_{k , t} = \frac{1}{N} {\sum }_{i = 1}^{N} {b}_{i , k , t} \qquad ( 12 )$$

The average value may be an arithmetic average value, a root mean square value, or a weighted average value. This is not limited.

The position history information of the terminal device obtained when the terminal device performs measurement T times may be represented by using the foregoing formula (4). In this case, the terminal device may calculate included angle cosine of frequency history information obtained after an i^{th} frequency is measured T times and the position history information by using formula (13).

$$cos ( \vec{s} , {\vec{p}}_{k} ) = \frac{\vec{s} \cdot {\vec{p}}_{k}}{\vert \vec{s} \vert \cdot \vert {\vec{p}}_{k} \vert} \qquad ( 13 )$$

Case 1: The frequency history information is one of a plurality of pieces of information.

For example, the frequency history information is RSRP. It is assumed that the network device delivers five frequencies: a frequency 1, a frequency 2, a frequency 3, a frequency 4, and a frequency 5, the terminal device measures the five frequencies five times, and position history information of the terminal device in the five times of measurement is \vec{s}=(s₁, s₂, . . . , s₅)=(10, 15, 12, 16, 18). If a first frequency (that is, the frequency 1) includes three beams, RSRP of the three beams measured in the five times of measurement is separately

\vec{b₁}=(b_{1,1,1},b_{1,1,2}, . . . ,b_{1,1,5})=(60,50,65,70,50),

\vec{b₂}=(b_{2,1,1},b_{2,1,2}, . . . ,b_{2,1,5})=(40,30,25,40,20), and

\vec{b₃}=(b_{3,1,1},b_{3,1,2}, . . . ,b_{3,1,5})=(50,34,30,22,14),

frequency history information that is of the first frequency and that is measured by using the foregoing formula (12) is:

\vec{p₁}=(p_{1,1},p_{1,2}, . . . ,p_{1,5})=(50,38,40,44,28).

The terminal device may calculate included angle cosine of the frequency history information of the first frequency and the corresponding position history information of the terminal device as follows by using the foregoing formula (13):

$$cos ( \vec{s} , {\vec{b}}_{1} ) = \frac{\vec{s} \cdot {\vec{b}}_{1}}{\vert \vec{s} \vert \cdot \vert {\vec{b}}_{1} \vert} = \frac{10 \times 50 + 15 \times 38 + 12 \times 40 + 16 \times 44 + 18 \times 28}{\sqrt{1 {0}^{2} + 1 {5}^{2} + 1 {2}^{2} + 1 {6}^{2} + 1 {8}^{2}} \times \sqrt{5 {0}^{2} + 3 {8}^{2} + 4 {0}^{2} + 4 {4}^{2} + 2 {8}^{2}}} = 0 \text{.98}$$

It is assumed that the fifth threshold is 0.5. Because the included angle cosine of the frequency history information of the first frequency and the corresponding position history information of the terminal device is 0.98, and is greater than the second threshold 0.5, the first frequency may be added to the target frequency set.

Similarly, for another frequency, a same method as the foregoing method may be used to determine whether to add the frequency to the target frequency set.

In some embodiments, the terminal device may alternatively first calculate included angle cosine of frequency history information of each frequency in all frequencies and corresponding position history information of the terminal device, and then combine frequencies whose included angle cosine is greater than the fifth threshold into the target frequency set in this application.

Case 2: The frequency history information is information obtained after at least two parameters in a plurality of pieces of information are processed.

For example, the frequency history information is RSRP and RSRQ. It is assumed that the network device delivers five frequencies: a frequency 1, a frequency 2, a frequency 3, a frequency 4, and a frequency 5. The terminal device measures the five frequencies five times, and position history information of the terminal device in the five times of measurement is \vec{s}=(s₁, s₂, . . . , s₅)=(10, 15, 12, 16, 18). RSRP of a first frequency (that is, the frequency 1) obtained by using the foregoing formula (12) is [symbol] =(p_{1,1}, p_{1,2}, . . . p_{1,5})=(50, 38, 40, 52, 36), and RSRQ of the first frequency is [symbol] =(p_{1,1}, p_{1,2}, . . . , p_{1,5})=(30, 34, 16, 24, 10). Therefore, frequency history information of the first frequency may be an average value of the RSRP and the RSRQ of the first frequency. An arithmetic average value is used as an example; in other words, the frequency history information of the first frequency is:

\vec{p₁}=(p_{1,1},p_{1,2}, . . . ,p_{1,5})=(40,36,28,38,23)

Included angle cosine of the frequency history information of the first frequency and the corresponding position history information of the terminal device may be calculated as follows by using the foregoing formula (13):

$$cos ( \vec{s} , {\vec{b}}_{1} ) = \frac{\vec{s} \cdot {\vec{b}}_{1}}{\vert \vec{s} \vert \cdot \vert {\vec{b}}_{1} \vert} = \frac{10 \times 40 + 15 \times 36 + 12 \times 28 + 16 \times 38 + 18 \times 23}{\sqrt{1 {0}^{2} + 1 {5}^{2} + 1 {2}^{2} + 1 {6}^{2} + 1 {8}^{2}} \times \sqrt{4 {0}^{2} + 3 {6}^{2} + 2 {8}^{2} + 3 {8}^{2} + 2 {3}^{2}}} = 0 \text{.99}$$

It is assumed that the fifth threshold is 0.5. Because the included angle cosine of the frequency history information of the first frequency and the corresponding position history information of the terminal device is 0.99, and is greater than the second threshold 0.5, the first frequency may be added to the target frequency set.

Similarly, for another frequency, a same method as the foregoing method may be used to determine whether to add the frequency to the target frequency set.

In some embodiments, the terminal device may alternatively first calculate included angle cosine of frequency history information of each frequency in all frequencies and corresponding position history information of the terminal device, and then combine frequencies whose included angle cosine is greater than the fifth threshold into the target frequency set in this application.

After determining the target frequency set, the terminal device may predict a target beam set of frequencies included in the target frequency set. For details, refer to the method shown in the manner 1 or the manner 2. For brief introduction, details are not described herein again.

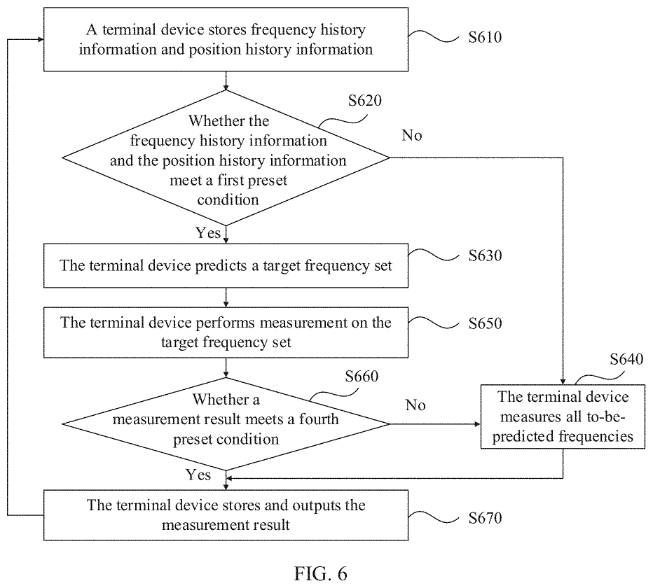

For ease of understanding, the method in the manner 3 is summarized below with reference to FIG. 6. FIG. 6 is a schematic flowchart of a prediction method according to still another embodiment of this application. The method may include step S610 to step S670.

S610: A terminal device stores frequency history information and position history information.

S620: Determine whether the frequency history information and the position history information meet a first preset condition.

If yes, step S630 is performed; and if no, step S640 is performed.

S630: The terminal device predicts a target frequency set.

S640: The terminal device measures all to-be-predicted frequencies.

S650: The terminal device performs measurement on the target frequency set.

S660: Determine whether a measurement result meets a fourth preset condition.

If yes, step S670 is performed; and if no, step S640 is performed.

S670: The terminal device stores and outputs the measurement result.

For step S610 to step S630, refer to content of the foregoing manner 3, and for step S640 to step S670, refer to related content of the fourth preset condition below. For brevity, details are not described herein again.

Based on this, several manners in which the terminal device predicts the target beam set and/or the target frequency set are mainly described above, and content related to measurement performed by the terminal device on the predicted target beam set and/or the predicted target frequency set is described below.

Optionally, in some embodiments, the method may further include: The terminal device measures the target beam set and/or the target frequency set to obtain a measurement result; and if the measurement result meets a fourth preset condition, the terminal device outputs the measurement result; or if the measurement result does not meet the fourth preset condition, the terminal device measures the beam set or the frequency set delivered by the network device.

In this embodiment of this application, after predicting the target beam set and/or the target frequency set, the terminal device may first perform measurement on the predicted target beam set and/or the predicted target frequency set. If a measurement result meets the fourth preset condition, the terminal device may output the measurement result, so that the terminal device performs next prediction. Ifthe measurement result does not meet the preset condition, the terminal device may perform measurement on the beam set or the frequency set delivered by the network device.

The measurement result in this embodiment of this application may be at least one of an SNR, an SINR, RSRP, or RSRQ mentioned above.

In the solution provided in this embodiment of this application, the terminal device determines, by using a result of measurement on the predicted target beam set and/or the predicted target frequency set, whether to perform comprehensive measurement, so that practicality of the measurement result is ensured while measurement is accelerated and energy is saved.

Optionally, in some embodiments, the fourth preset condition includes at least one of the following conditions:

actual beam strength measured by the terminal device in the target beam set and/or the target frequency set meets a threshold required for cell handover;

an absolute value of an error between actual beam strength measured by the terminal device in the target beam set and/or the target frequency set and expected beam strength corresponding to the target beam set and/or the target frequency set is less than or equal to a sixth threshold;

a weighted sum of an error between actual beam strength measured by the terminal device in the target beam set and/or the target frequency set and expected beam strength corresponding to the target beam set and/or the target frequency set is less than or equal to a seventh threshold; and

actual beam strength measured by the terminal device and actual position information meet the second preset condition and/or the third preset condition.

In this embodiment of this application, the terminal device may perform measurement on the predicted target beam set and/or the predicted target frequency set to obtain the measurement result. The measurement result may be actual beam strength, for example, may be any one of an SNR, an SINR, RSRP, or RSRQ.

RSRP is used as an example. If the target beam set predicted by the terminal device includes three beams: a beam 1, a beam 2, and a beam 3, the terminal device may separately perform measurement on the three beams.
(1) The fourth preset condition is that actual beam strength measured by the terminal device in the target beam set meets a threshold required for cell handover.
\textcircled{1} It is assumed that RSRP obtained through measurement on the three beams is respectively 30 dBm, 50 dBm, and 38 dBm. If the terminal device is currently located on the beam 1 and the threshold required for cell handover is 40 dBm, the terminal device may output a measurement result of the beam 3.
\textcircled{2} It is assumed that RSRP obtained through measurement on the three beams is respectively 30 dBm, 25 dBm, and 38 dBm. If the terminal device is currently located on the beam 1 and the threshold required for cell handover is 40 dBm, the terminal device may perform measurement on all beams delivered by the network device.
(2) The fourth preset condition is that an absolute value of an error between actual beam strength measured by the terminal device in the target beam set and expected beam strength corresponding to the target beam set is less than or equal to a sixth threshold.
\textcircled{1} It is assumed that RSRP obtained through measurement on the three beams is respectively 30 dBm, 50 dBm, and 38 dBm. If expected RSRP obtained through measurement on the three beams is respectively 35 dBm, 70 dBm, and 45 dBm, and the sixth threshold is 10 dBm, the terminal device may output measurement results of the beam 1 and the beam 3.
\textcircled{2} It is assumed that RSRP obtained through measurement on the three beams is respectively 30 dBm, 50 dBm, and 38 dBm. If expected RSRP obtained through measurement on the three beams is respectively 50 dBm, 70 dBm, and 20 dBm, and the sixth threshold is 10 dBm, the terminal device may perform measurement on all beams delivered by the network device.
(3) The fourth preset condition is that a weighted sum of an error between actual beam strength measured by the terminal device in the target beam set and expected beam strength corresponding to the target beam set is less than or equal to a seventh threshold.
\textcircled{1} It is assumed that RSRP obtained after the three beams are measured for a first time is respectively 30 dBm, 50 dBm, and 38 dBm, and RSRP obtained after the three beams are measured for a second time is respectively 40 dBm, 25 dBm, and 40 dBm. If expected RSRP obtained through measurement on the three beams is respectively 35 dBm, 60 dBm, and 45 dBm, errors between RSRP obtained after the three beams are measured for different times and the expected RSRP may be separately calculated.

At the first time, errors between RSRP obtained after the three beams are measured and the expected RSRP are respectively −5, −10, and −7.

At the second time, errors between RSRP obtained after the three beams are measured and the expected RSRP are respectively 5, −35, and −5.

Weighted sums of errors obtained in different times of measurement are calculated. It is assumed that a weighting coefficient at the first time of measurement is 0.4 and a weighting coefficient at the second time of measurement is 0.6, and weighted sums of errors between actual beam strength obtained after the three beams are measured and expected beam strength corresponding to the three beams are obtained.

For the beam 1, 5*0.4+5*0.6=5.

For the beam 2, 10*0.4+35*0.6=25.

For the beam 3, 7*0.4+5*0.6=5.8.

The seventh threshold is 10 dBm. Because the weighted sum of the errors between the actual beam strength of the beam 1 and the expected beam strength corresponding to the beam 1 is less than the seventh threshold and the weighted sum of the errors between the actual beam strength of the beam 3 and the expected beam strength corresponding to the beam 3 is less than the seventh threshold, the terminal device may output measurement results of the beam 1 and the beam 3.

\textcircled{2} It is assumed that RSRP obtained after the three beams are measured for a first time is respectively 20 dBm, 40 dBm, and 30 dBm, and RSRP obtained after the three beams are measured for a second time is respectively 45 dBm, 30 dBm, and 20 dBm. If expected RSRP obtained through measurement on the three beams is respectively 35 dBm, 60 dBm, and 45 dBm, errors between RSRP obtained after the three beams are measured for different times and the expected RSRP may be separately calculated.

At the first time, errors between RSRP obtained after the three beams are measured and the expected RSRP are respectively −15, −20, and −15.

At the second time, errors between RSRP obtained after the three beams are measured and the expected RSRP are respectively 10, −30, and −25.

Weighted sums of errors obtained in different times of measurement are calculated. It is assumed that a weighting coefficient at the first time of measurement is 0.4 and a weighting coefficient at the second time of measurement is 0.6, and weighted sums of errors between actual beam strength obtained after the three beams are measured and expected beam strength corresponding to the three beams are obtained.

For the beam 1, 15*0.4+10*0.6=12.

For the beam 2, 20*0.4+30*0.6=26.

For the beam 3, 15*0.4+25*0.6=21.

If the seventh threshold is 10 dBm, because the weighted sum of the errors between the actual beam strength of the beam 1 and the expected beam strength corresponding to the beam 1 is greater than the seventh threshold, the weighted sum of the errors between the actual beam strength of the beam 2 and the expected beam strength corresponding to the beam 2 is greater than the seventh threshold, and the weighted sum of the errors between the actual beam strength of the beam 3 and the expected beam strength corresponding to the beam 3 is greater than the seventh threshold, the terminal device may perform measurement on all beams delivered by the network device.
(4) The terminal device determines, based on actual beam strength measured by the terminal device at a current time and actual position information, that the second preset condition and/or the third preset condition are/is met.

It is assumed that RSRP obtained by the terminal device by performing measurement on the three beams at a t^{th} time is respectively 30 dBm, 50 dBm, and 18 dBm, and RSRP obtained at a (t−1)^{th} time of measurement is respectively 40 dBm, 35 dBm, and 30 dBm. It may be determined whether an absolute value of included angle cosine of RSRP obtained by performing measurement on each beam for different times and corresponding position history information of the terminal device is greater than or equal to the third threshold.

It is assumed that position history information of the terminal device in the two times of measurement is \vec{s}=(s₁, s₂)=(10, 15). Included angle cosine of RSRP obtained by performing measurement on the three beams for different times and corresponding position history information of the terminal device may be separately calculated by using the foregoing formula (9).

$$cos ( \vec{s} , {\vec{b}}_{1} ) = \frac{\vec{s} \cdot {\vec{b}}_{1}}{\vert \vec{s} \vert \cdot \vert {\vec{b}}_{1} \vert} = \frac{10 \times 40 + 15 \times 30}{\sqrt{1 {0}^{2} + 1 {5}^{2}} \times \sqrt{4 {0}^{2} + 3 {0}^{2}}} = 0 \text{.61} \qquad Beam 1$$

$$cos ( \vec{s} , {\vec{b}}_{2} ) = \frac{\vec{s} \cdot {\vec{b}}_{2}}{\vert \vec{s} \vert \cdot \vert {\vec{b}}_{2} \vert} = \frac{10 \times 35 + 15 \times 50}{\sqrt{1 {0}^{2} + 1 {5}^{2}} \times \sqrt{3 {5}^{2} + 5 {0}^{2}}} = 0.99 \qquad Beam 2$$

$$cos ( \vec{s} , {\vec{b}}_{3} ) = \frac{\vec{s} \cdot {\vec{b}}_{3}}{\vert \vec{s} \vert \cdot \vert {\vec{b}}_{3} \vert} = \frac{10 \times 30 + 15 \times 18}{\sqrt{1 {0}^{2} + 1 {5}^{2}} \times \sqrt{3 {0}^{2} + 1 {8}^{2}}} = 0.90 \qquad Beam 3$$

If the third threshold is 0.5, because the included angle cosine of the RSRP obtained by performing measurement on the beam 1, the beam 2, and the beam 3 for different times and the corresponding position history information of the terminal device is greater than the third threshold, the terminal device may output measurement results of the beam 1, the beam 2, and the beam 3.

It should be understood that the foregoing values are merely examples for description, and may alternatively be other values. This should not constitute a special limitation on this application.

The target beam set is used as an example above for description. The target frequency set is similar to the foregoing process. For brevity, details are not described herein again.

It should be noted that the threshold involved in this application may be fixed, or may be continuously adjusted. This is not limited.

Optionally, in some embodiments, that the terminal device determines that first information and second information meet a first preset condition includes: In response to indication information received by the terminal device, the terminal device determines that the first information and the second information meet the first preset condition, where the indication information is used to indicate the terminal device to perform beam prediction.

In this embodiment of this application, if the terminal device receives the indication information sent by the network device, the terminal device may perform beam prediction in response to the indication information, that is, may start to determine that the first information and the second information meet the first preset condition.

It should be understood that in some embodiments, when the terminal device does not receive the indication information sent by the network device, beam prediction may also be started.

The indication information in this embodiment of this application may be separately sent by using a message; or may be sent together with specific information, and the information and the indication information in this application may be jointly included in a specific message. This is not limited.

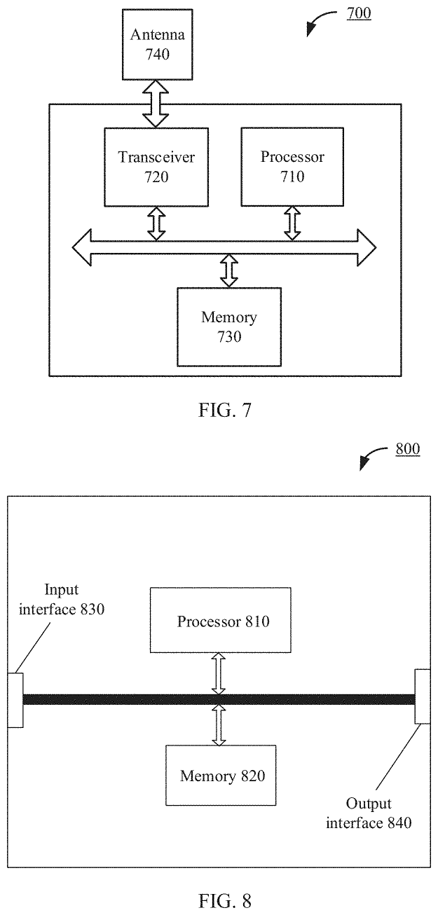

The prediction method provided in embodiments of this application is described in detail above with reference to FIG. 1 to FIG. 6. A device side in embodiments of this application is described below with reference to FIG. 7 and FIG. 8.

FIG. 7 is a schematic diagram of a structure of a terminal device 700 according to an embodiment of this application. The terminal device 700 may include a processor 710.

The processor 710 is configured to:

determine that first information and second information meet a first preset condition, where the first information is beam history information of at least one beam and/or frequency history information of at least one frequency, and the second information is position history information of the terminal device; and

predict a target beam set and/or a target frequency set based on the first information and the second information, where the target beam set is a subset of a beam set delivered by a network device, and the target frequency set is a subset of a frequency set delivered by the network device.

Optionally, in some embodiments, the first preset condition is at least one of the following conditions:

an absolute value of included angle cosine of information including included angle cosine of the first information measured in different times and the second information is greater than or equal to a first threshold, and an absolute value of a correlation coefficient of the information including the included angle cosine of the first information measured in different times and the second information is greater than or equal to a second threshold.

Optionally, in some embodiments, the processor 710 is further configured to:

determine beam history information obtained after each of the at least one beam is measured T times and corresponding position history information of the terminal device; and predict the target beam set based on the beam history information obtained after each beam is measured T times and the position history information.

Optionally, in some embodiments, the processor 710 is further configured to:

if n1 beams in the at least one beam meet a second preset condition, combine the n1 beams into the target beam set, where the second preset condition includes: an absolute value of included angle cosine of beam history information obtained by the terminal device by performing measurement T times on each of the n1 beams and the position history information is greater than or equal to a third threshold, where n1 is a positive integer greater than or equal to 1.

Optionally, in some embodiments, the processor 710 is further configured to:

construct a first sequence based on the second information, where the first sequence includes beam history information obtained after the at least one beam is measured T times; and select m beams from the first sequence, and combine the m beams into the target beam set, where the m beams are beams whose beam history information is greater than or equal to a fourth threshold in the first sequence.

Optionally, in some embodiments, the processor 710 is further configured to:

determine frequency history information obtained after each of the at least one frequency is measured T times and corresponding position history information of the terminal device; and predict the target frequency set based on the frequency history information obtained after each frequency is measured T times and the position history information.

Optionally, in some embodiments, the processor 710 is further configured to:

if n2 frequencies in the at least one frequency meet a third preset condition, combine the n2 frequencies into the target frequency set, where the third preset condition includes: an absolute value of included angle cosine of frequency history information obtained by the terminal device by performing measurement T times on each of the n2 frequencies and the position history information is greater than a fifth threshold, where n2 is a positive integer greater than or equal to 1.

Optionally, in some embodiments, the beam history information includes at least one of the following information:

a signal to noise ratio SNR of each of the at least one beam, a signal to interference plus noise ratio SINR of each of the at least one beam, reference signal received power RSRP of each of the at least one beam, reference signal received quality RSRQ of each of the at least one beam, duration in which the terminal device camps on each of the at least one beam, and a moment/sequence in which the terminal device measures each of the at least one beam.

Optionally, in some embodiments, the frequency history information includes at least one of the following information:

an average value of SNRs of beams included at each of the at least one frequency, an average value of SINRs included at each of the at least one frequency, RSRP included at each of the at least one frequency, RSRQ included at each of the at least one frequency, duration in which the terminal device camps on the at least one frequency, and a moment/sequence in which the terminal device measures the at least one frequency.

Optionally, in some embodiments, the position history information includes at least one of the following information:

a position at which the terminal device performs measurement, a speed at which the terminal device performs measurement, and an acceleration at which the terminal device performs measurement.

Optionally, in some embodiments, the processor 710 is further configured to:

measure the target beam set and/or the target frequency set to obtain a measurement result; and

if the measurement result meets a fourth preset condition, output the measurement result; or

if the measurement result does not meet the fourth preset condition, measure the beam set or the frequency set delivered by the network device.

Optionally, in some embodiments, the fourth preset condition includes at least one of the following conditions:

actual beam strength measured by the terminal device in the target beam set and/or the target frequency set meets a threshold required for cell handover;

an absolute value of an error between actual beam strength measured by the terminal device in the target beam set and/or the target frequency set and expected beam strength corresponding to the target beam set and/or the target frequency set is less than or equal to a sixth threshold;

a weighted sum of an error between actual beam strength measured by the terminal device in the target beam set and/or the target frequency set and expected beam strength corresponding to the target beam set and/or the target frequency set is less than or equal to a seventh threshold; and

actual beam strength measured by the terminal device and actual position information meet the second preset condition and/or the third preset condition.

Optionally, in some embodiments, the processor 710 is further configured to:

in response to indication information received by the terminal device, determine that the first information and the second information meet the first preset condition, where the indication information is used to indicate the terminal device to perform beam prediction.

Optionally, in some embodiments, the terminal device 700 may further include a transceiver 720 and a memory 730. The processor 710, the transceiver 720, and the memory 730 communicate with each other by using an internal connection path to transfer a control and/or data signal. The memory 730 is configured to store a computer program. The processor 710 is configured to invoke the computer program from the memory 730 and run the computer program, to control the transceiver 720 to receive and send a signal.

The processor 710 and the memory 730 may be combined into a processing apparatus. The processor 710 is configured to execute program code stored in the memory 730 to implement a function of the terminal device in the foregoing method embodiments. In specific implementation, the memory 730 may alternatively be integrated into the processor 710, or is independent of the processor 710. The transceiver 720 may be implemented in a transceiver circuit manner.

The terminal device 700 may further include an antenna 740, configured to send, by using a wireless signal, downlink data or downlink control signaling that is output by the transceiver 720, or receive uplink data or uplink control signaling and then send the uplink data or the uplink control signaling to the transceiver 720 for further processing.

FIG. 8 is a schematic diagram of a structure of a chip 800 according to an embodiment of this application. The chip 800 shown in FIG. 8 includes a processor 810, and the processor 810 may invoke a computer program from a memory and run the computer program, to implement the method in this embodiment of this application.

Optionally, as shown in FIG. 8, the chip 800 may further include a memory 820. The processor 810 may invoke a computer program from the memory 820 and run the computer program, to perform the steps in the method in embodiments of this application.

The memory 820 may be a separate component independent of the processor 810, or may be integrated into the processor 810.

Optionally, the chip 800 may further include an input interface 830. The processor 810 may control the input interface 830 to communicate with another device or chip, and specifically, information or data sent by the another device or chip may be obtained.

Optionally, the chip 800 may further include an output interface 840. The processor 810 may control the output interface 840 to communicate with another device or chip, and specifically, information or data may be output to the another device or chip.

Optionally, the chip may be applied to the terminal device in embodiments of this application, and the chip may implement a corresponding procedure implemented by the terminal device in the methods in embodiments of this application. For brevity, details are not described herein again.

It should be understood that the chip mentioned in this embodiment of this application may also be referred to as a system-level chip, a system chip, a chip system, or a system-on-a-chip.

An embodiment of this application further provides a computer-readable storage medium configured to store a computer program.

Optionally, the computer-readable storage medium may be applied to the terminal device in embodiments of this application, and the computer program enables a computer to perform a corresponding procedure implemented by the terminal device in the methods in embodiments of this application. For brevity, details are not described herein again.

An embodiment of this application further provides a computer program product including computer program instructions.

Optionally, the computer program product may be applied to the terminal device in embodiments of this application, and the computer program instructions enable a computer to perform a corresponding procedure implemented by the terminal device in the methods in embodiments of this application. For brevity, details are not described herein again.

An embodiment of this application further provides a computer program.

Optionally, the computer program may be applied to the terminal device in embodiments of this application. When the computer program is run on a computer, the computer is enabled to perform a corresponding procedure implemented by the terminal device in the methods in embodiments of this application. For brevity, details are not described herein again.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In several embodiments provided in this application, it should be understood that the disclosed system, apparatus, and method may be implemented in another manner. For example, the described apparatus embodiments are merely examples. For example, division into the modules is merely logical function division and may be other division in actual implementation. For example, a plurality of modules or components may be combined. In addition, the displayed or discussed mutual coupling or communication connection may be indirect coupling or an indirect communication connection established by using some interfaces, apparatuses, or units.

In addition, functional units in embodiments of this application may be integrated into one physical entity, or each unit may correspond to one physical entity, or two or more units may be integrated into one physical entity.

When the functions are implemented in the form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, or a network device) to perform all or some of the steps of the methods described in embodiments of this application. The foregoing storage medium includes any medium that can store program code, such as a USB flash drive, a removable hard disk, a read-only memory (read-only memory, ROM), a random access memory (random access memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1.-28. (canceled)

29. A method implemented by a terminal device, wherein the method comprises:
determining that first information and second information meet a first preset condition, wherein the first information comprises first beam history information of at least one beam or first frequency history information of at least one frequency, and wherein the second information comprises position history information of the terminal device; and
predicting a target beam set or a target frequency set based on the first information and the second information,
wherein the target beam set is a first subset of a beam set from a network device, and
wherein the target frequency set is a second subset of a frequency set from the network device.

30. The method of claim 29, wherein the first preset condition comprises at least one of:
a first absolute value of a first included angle cosine of third information comprises a second included angle cosine of the first information measured at different times, wherein the second information is greater than or equal to a first threshold; or
a second absolute value of a correlation coefficient of the third information is greater than or equal to a second threshold.

31. The method of claim 29, further comprising:
obtaining second beam history information after each of the at least one beam is measured T times;
obtaining position history information corresponding to the second beam history information; and
predicting the target beam set based on the second beam history information and the corresponding position history information.

32. The method of claim 31, further comprising:
identifying that n1 beams in the at least one beam meet a second preset condition, wherein the second preset condition comprises an absolute value of an included angle cosine of third beam history information obtained by the terminal device by performing measurement T times on each of the n1 beams and the corresponding position history information is greater than or equal to a threshold, and wherein n1 is a positive integer greater than or equal to one; and
combining, in response to identifying that the n1 beams meet the second preset condition, the n1 beams into the target beam set.

33. The method of claim 29, further comprising:
obtaining second beam history information after the at least one beam is measured T times;
constructing, based on the second information, a first sequence comprising the second beam history information;
selecting m beams from the first sequence, wherein m is a positive integer greater than or equal to one, and wherein the m beams comprise third beam history information that is greater than or equal to a threshold in the first sequence; and
combining the m beams into the target beam set.

34. The method of claim 29, further comprising:
obtaining second frequency history information after each of the at least one frequency is measured T times;
obtaining position history information corresponding to the second frequency history information; and
predicting the target frequency set based on the second frequency history information and the corresponding position history information.

35. The method of claim 34, further comprising:
identifying that n2 frequencies in the at least one frequency meet a third preset condition, wherein the third preset condition comprises an absolute an absolute value of an included angle cosine of third frequency history information obtained by the terminal device by performing measurement T times on each of the n2 frequencies, wherein the corresponding position history information is greater than a threshold, and wherein n2 is a positive integer greater than or equal to one; and
combining, in response to identifying that the n2 frequencies meet the third preset condition, the n2 frequencies into the target frequency set.

36. The method of claim 29, wherein the first beam history information comprises at least one of:
a signal-to-noise ratio (SNR) of each of the at least one beam;
a signal-to-interference-plus-noise ratio (SINR) of each of the at least one beam;
reference signal received power (RSRP) of each of the at least one beam;
reference signal received quality (RSRQ) of each of the at least one beam;
a duration in which the terminal device camps on each of the at least one beam; or
a moment/sequence in which the terminal device measures each of the at least one beam.

37. The method of claim 29, wherein the first frequency history information comprises at least one of:
a first average value of signal-to-noise ratios (SNRs) of beams at each of the at least one frequency;
a second average value of signal-to-interference-plus-noise ratios (SINRs) at each of the at least one frequency;
reference signal received power (RSRP) at each of the at least one frequency;
reference signal received quality (RSRQ) at each of the at least one frequency;
a duration in which the terminal device camps on the at least one frequency; or
a moment/sequence in which the terminal device measures the at least one frequency.

38. The method of claim 29, wherein the position history information comprises at least one of:
a position at which the terminal device performs a measurement;
a speed at which the terminal device performs a measurement; or
an acceleration at which the terminal device performs a measurement.

39. The method of claim 29, further comprising:
measuring the target beam set or the target frequency set to obtain a measurement result;
outputting the measurement result when the measurement result meets a fourth preset condition; and
measuring the beam set or the frequency set when the measurement result does not meet the fourth preset condition.

40. The method of claim 39, wherein the fourth preset condition comprises at least one of:
an actual beam strength measured by the terminal device in the target beam set or the target frequency set meets a first threshold required for cell handover;
a first absolute value of an error between the actual beam strength and an expected beam strength corresponding to the target beam set or the target frequency set is less than or equal to a second threshold;
a weighted sum of the error is less than or equal to a third threshold; or
wherein the actual beam strength and actual position information meet a second preset condition or a third preset condition,
wherein the second preset condition comprises a second absolute value of a first included angle cosine of second beam history information obtained by the terminal device by performing measurement T times on each of n1 beams in the at least one beam and first corresponding position history information is greater than or equal to a fourth threshold,
wherein n1 is a positive integer greater than or equal to one,
wherein the third preset condition comprises a third absolute value of a second included angle cosine of second frequency history information obtained by the terminal device by performing measurement T times on each of n2 frequencies in the at least one frequency and second corresponding position history information is greater than a fifth threshold, and
wherein n2 is a positive integer greater than or equal to one.

41. The method of claim 29, further comprising:
receiving indication information instructing the terminal device to perform beam prediction; and
further determining, in response to receiving the indication information, that the first information and the second information meet the first preset condition.

42. A terminal device comprising:
a memory configured to store instructions; and
a processor coupled to the memory and configured to execute the instructions to cause the terminal device to:
determine that first information and second information meet a first preset condition, wherein the first information comprises first beam history information of at least one beam or first frequency history information of at least one frequency, and wherein the second information comprises position history information of the terminal device; and
predict a target beam set or a target frequency set based on the first information and the second information, wherein the target beam set is a first subset of a beam set from a network device, and wherein the target frequency set is a second subset of a frequency set from the network device.

43. The terminal device of claim 42, wherein the first preset condition comprises at least one of:
a first absolute value of a first included angle cosine of third information comprises a second included angle cosine of the first information measured at different times, wherein the second information is greater than or equal to a first threshold; or
a second absolute value of a correlation coefficient of the third information is greater than or equal to a second threshold.

44. The terminal device of claim 42, wherein the processor is further configured to execute the instructions to cause the terminal device to:
obtain second beam history information after each of the at least one beam is measured T times;
obtain position history information corresponding to the second beam history information; and
predict the target beam set based on the second beam history information and the corresponding position history information.

45. The terminal device of claim 44, wherein the processor is further configured to execute the instructions to cause the terminal device to:
identify that n1 beams in the at least one beam meet a second preset condition, wherein the second preset condition comprises an absolute value of an included angle cosine of third beam history information obtained by the terminal device by performing measurement T times on each of the n1 beams and the corresponding position history information is greater than or equal to a threshold, and wherein n1 is a positive integer greater than or equal to one; and
combine, in response to identifying that the n1 beams meet the second preset condition, the n1 beams into the target beam set.

46. The terminal device according to claim 42, wherein the processor is further configured to execute the instructions to cause the terminal device to:
obtain second beam history information after the at least one beam is measured T times;
construct, based on the second information, a first sequence comprising the second beam history information;
select m beams from the first sequence, wherein m is a positive integer greater than or equal to one, and wherein the m beams comprise third beam history information that is greater than or equal to a threshold in the first sequence; and
combine the m beams into the target beam set.

47. The terminal device of claim 42, wherein the processor is further configured to execute the instructions to cause the terminal device to:
obtain second frequency history information after each of the at least one frequency is measured T times;
obtain position history information corresponding to the second frequency history information; and
predict the target frequency set based on the second frequency history information and the corresponding position history information.

48. The terminal device of claim 47, wherein the processor is further configured to execute the instructions to cause the terminal device to:
identify that n2 frequencies in the at least one frequency meet a third preset condition, wherein the third preset condition comprises an absolute value of an included angle cosine of third frequency history information obtained by the terminal device by performing measurement T times on each of the n2 frequencies, wherein the corresponding position history information is greater than a threshold, and wherein n2 is a positive integer greater than or equal to 1; and
combine, in response to identifying that the n2 frequencies meet the third preset condition, the n2 frequencies into the target frequency set.
